(19) United States
(12) Patent Application Publication
(10) Pub. No.: US 2004/0068329 A1
(43) Pub. Date: Apr. 8, 2004

(54) Method and apparatus for general purpose computing

(76) Inventor: Robert Keith Mykland, Capitola, CA (US)

Correspondence Address: PATRICK REILLY, BOX 7218, SANTA CRUZ, CA, 95061-7218, US

(21) Appl. No.: 10/128,940

(22) Filed: Apr. 24, 2002

Related U.S. Application Data
(60) Provisional application No. 60/288,986, filed on May 4, 2001.

(51) Int. Cl. G05B 11/01; G05B 19/42

(52) U.S. Cl. 700/18; 700/86

(57) ABSTRACT

A general purpose computing system comprises a novel apparatus and method for data processing. The computing system design of one application of the present invention includes an instruction pipe having, decompression circuit, a reprogrammable logic unit and a data bus. Instructions and data may be accessed via a shared bus or via a separate instruction bus and data bus. The decompression circuit accepts compressed instructions and memory management directives from the instruction bus, decompresses each instruction, and transmits the decompressed instruction to the reprogrammable logic unit. The decompression circuit may be hardwired, or reprogrammable, or consist of a combination of permanent logic and reprogrammable logic. The reprogrammable logic unit includes a multiplicity of individual functional circuits, including a novel and invented circuits such as iterators, invented muxes, invented cones and look up table circuits. These individual functional circuits may be reprogrammed in relationship to each other and optionally to the instruction and data buses in accordance with the instruction received from the instruction bus. Additionally, their internal logical states are programmable. The present invention thereby enables the efficient computation of complex instructions by means of reprogramming the logic relationships of the individual functional circuits of the reprogrammable logic unit and of the internal logic states the functional circuits. A software compiler is provided that accepts high level programming language source code and creates instructions that are coded for acceptance and execution by the reprogrammable logic unit. The present invention provides an extremely powerful general-purpose computer that can be configured to execute and multitask high-level language programs under commercially dominant event driven operating systems. Certain configurations of the present invention are effective as or within alternative, plug and play computing elements of existing computer models and architectures.

### CONTINUATION-IN-PART

This application claims benefit of the priority date of filing of May 4, 2001, of Provisional Patent Application File Serial No. 60/288,986.

### BACKGROUND OF THE INVENTION

The present invention relates to the architecture of computing systems. More particularly, the present invention addresses requirements to flexibly apply the capabilities of reprogrammable logic to the tasks of general purpose computing.

Field of the Invention

Electronic information storage and management is a fundamental aspect of most business and government activities in the industrialized world. Improvements in the art of computing system design and operating method can have profound effects in the operational efficiencies of numerous organizations and entire sectors of the world economy.

It is well known in the art of computer systems design that an especially designed electronic logic circuit can often execute highly complex algorithms at rates superior to conventional general purpose computers. Yet the prior art applications and methods of using programmable logic fail to embody algorithms in programmable logic such that the reprogrammable logic can significantly and beneficially enable the general purpose application of high level computer language code and particularly event driven high level computer language code in the programming of these prior art systems.

There is, therefore, a long felt need in the art of computer design to apply the advantages of dedicated logic circuits in the execution of programs derived from high level computer languages and under the control of commercially prevalent operating systems and particularly event driven operating systems.

### OBJECTS OF THE INVENTION

It is an object of the present invention to provide a computer architecture that uses reprogrammable logic in software program execution.

It is yet another object of the present invention to provide a computer system that includes reprogrammable logic and can execute at least one operating system.

### SUMMARY OF THE INVENTION

According to the present invention, a computing device, or central processor, is provided. The preferred embodiment, or invented general-purpose computer, includes an integrated circuit computing device having an instruction pipe having an optional instruction decompression circuit 20, a reprogrammable logic unit, and a data pipe. The data pipe may be coupled with a data bus and/or a data source, such as a memory device or bus. The data pipe may be optionally coupled with a data target, such as a data bus or a memory, to which the computational results of the RLU are communicated via the data pipe. Alternately, the data pipe may be comprised of a separate data input pipe and a data output pipe, wherein data is communicated to the RLU from the data source via the data input pipe, and output from the RLU, e.g., computational results, are communicated to the data target via the data output pipe. The instruction pipe may be coupled with an instruction source, such as a memory device or bus. The data source, the data target and/or the instruction source may be comprised within a single memory device. The instruction pipe and the data pipe may optionally include the same communications bus circuitry in whole or in part, whereby data and instructions may be transmitted via elements of the same communications bus either simultaneously on different elements or in a multiplexed technique via one or more, or all, shared resource components of the communications bus. In certain alternate preferred embodiments of the present invention, the operating system executed by the integrated circuit computing device may be MICROSOFT NT, MICROSOFT WINDOWS 98, MAC O/S 10, LINUX, or another suitable operating system known in the art.

In certain alternate preferred methods of the present invention, the reprogrammable logic unit, or RLU, may include pluralities or multiplicities of specific functional types of electronic logic circuits, to include but not limited to invented muxes, invented cones, invented iterators and/or look up tables. The outputs of certain of these functional electronic logic circuit types may be reprogrammably placed in communication with the inputs of certain functional electronic logic circuits. In certain still alternate preferred embodiments of the present invention, one or more outputs of at least one functional electronic logic circuit may be reprogrammably linked to one or more inputs of the same, whereby a functional electronic logic circuit may provide an input from an output of itself. Certain yet alternate preferred embodiments of the present invention additionally provide for the programming of the internal logic state or states of a functional logic circuit as determined in part or in whole by the computations or direction of the functional logic circuit itself.

The method of the present invention enables the application of reprogrammable logic circuits within an integrated computing circuit device in combination with the provision of instructions generated by a software compiler. The software compiler analyzes the original source code and generates instructions that program and reprogram the interconnects between the reprogrammable logic elements and enable or disable logic within the elements themselves in sequences that support the rapid execution of the commands specified by the source code.

The instructions are software commands that are generated by a software compiler or another suitable means or method of generating or creating software machine code known in the art. The compiler may maintain a model of part or of the entire reprogrammable logic unit. The compiler accepts a source code and creates a series of instructions that enable the effective programming of the reprogrammable logic unit and cause the reprogrammable logic unit to execute the commands of the source code when the reprogrammable unit is executing the resultant instruction or series of instructions generated by the compilation of the source code. In certain preferred embodiments the source code may be in higher-level languages, such as C, C++, JAVA, or other suitable programming languages known in the art.

Certain preferred embodiments of the present invention include novel and invented electrical circuits and novel and inventive combinations of the invented circuits that have newly invented circuits and/or prior art circuits. A newly invented data mux circuit, or mux, may be configured to effectively perform data processing of general logic and math data, it may be configured to effectively create partial products for multiplication operations, and/or to perform bit shifting or bit selection. A newly invented cone circuit, or cone, is useful for the digital data processing actions of parallel carry, parallel borrow, basic logic on a large number of inputs, and the counting of leading zeroes. A newly invented iterator circuit, or iterator, is useful for input/output actions to/from the data pipe and for storage of results from one execution cycle to subsequent execution cycles. Prior art look up tables and each of the newly invented mux, cone and iterator circuits are implemented solely or in combination in certain alternate preferred embodiments of the present invention.

A preferred embodiment of the data mux circuit has three inputs (data) feeding into eight three-input AND gates enabled by eight bits of RAM (instruction space). Each of the AND gates has one of eight possible configurations of straight and inverted signals.

Eight outputs of the eight AND gates may then be connected to an eight input OR gate, from which a single data logic level output is produced. Since only one of the AND gates can be high at any given time, the logic of this circuit can be embodied in eight multiple enable buffers tied to the eight RAM bits. The title of mux was chosen for this newly invented circuit from the fact that the input stage is logically a three to eight demultiplexer. One of the possibilities of certain preferred embodiments of the present invention is to provide a reconfigurable logic unit, or RLU, that does digital math and logic processing. Here are some of the functions that the mux may be configured to perform:

Two or three input logic circuits, such as:

A xor B is 0×66;

A and B and C is 0×8, and

A or B or C is 0×FE.

Many useful digital math circuits, such as:

Sum bit of an add is 0×96;

Difference bit of a subtract is 0×69; and

Carry bit of a Wallace tree node is 0×E8.

A plurality of muxes can be configured to produce the results of partial products. Given the basic mux circuit described above, instead of the RAM bits feeding into the eight buffers, one could design a mux having the outputs of eight surrounding muxes (as one possibility) feeding into the eight buffers the mux. For a general partial product bit, the result could be programmed as follows:

For multiplier bits A, B, and C and multiplicand bits X and Y:

Mux 0 gives 0 and feeds into bit 0 of the master mux;

Mux 1 gives Y and feeds into bit 1 of the master mux;

Mux 2 gives Y and feeds into bit 2 of the master mux;

Mux 3 gives X and feeds into bit 3 of the master mux;

Mux 4 gives /X and feeds into bit 4 of the master mux;

Mux 5 gives /Y and feeds into bit 5 of the master mux;

Mux 6 gives /Y and feeds into bit 6 of the master mux;

Mux 7 gives 0 and feeds into bit 7 of the master mux; and;

The master mux buffers being controlled by A, B, C.

Partial products and other similar complex logical quantities may thereby be created in muxes. Other suitable eight-mux operations could be combined this way.

Muxes may also be configured for bit shifting or bit selection. Instead of eight RAM bits, eight data inputs could be applied to the eight buffers of a mux. If the three mux inputs were a binary number, that data bit would be propagated through the circuit. This would allow one to logically shift among eight signals. One stage of such a circuit could shift or rotate a number right or left by up to seven bits. Two stages would shift up to 63 bits, and so on.

The title cone was chosen for the cone circuit from the word concentrator and the sense that these circuits are here to provide a fan-in capability. Cones configured for carry and borrow operations may have one of the following forms:

Mode zero is for higher stages of parallel carry or borrow;

Mode one is for parallel carry inputs;

Mode two is for the low eight input bits of parallel borrow; and

Mode three is for input bits higher than eight in a parallel borrow.

Modes one, two, and three accept the first operand on the low eight input bits and the second operand on the upper eight input bits. They output the eight parallel carry products on the low eight outputs. On the upper eight outputs they provide the OR products of the input bits (i.e. bit 3 of this would be (a0|b0) & (a1|b1) & (a2|b2) & (a3|b3)).

Mode zero accepts partial carry products from other cones on its low eight bits and OR products from other cones on its upper eight bits, using these to form higher order carry bits.

Cones are also useful for logical operations involving more than three inputs. Sometimes such operations are required in great numbers. A common need for this in digital math is counting leading zeroes and testing large numbers of bits equal to zeroes or ones.

In mode 4, for example, the cone meaning of the 16 cone outputs may be as follows:

0: AND of 16 inputs;

1: NAND of 16 inputs;

2: OR of 16 inputs;

3: NOR of 16 inputs;

4-7: A number between 0 and 15 specifying the position (from the left) of the first one in the inputs;

8: AND of lower 8 inputs;

9: NAND of lower 8 inputs;

10: OR of lower 8 inputs;

11: NOR of lower 8 inputs;

12: AND of upper 8 inputs;

13: NAND of upper 8 inputs;

14: OR of upper 8 inputs; and

15: NOR of upper 8 inputs.

An iterator circuit may be configured to perform input and output latch functions. To transition from the clocked circuitry of the data bus and the data pipe to the settling time world of the RLU, input and output latches may be required. The iterator may be used as either an input or output latch to the RLU. The title of iterator for this invented circuit comes from the latch's ability to store data from execution cycle to execution cycle (see below). It may be constructive to imagine an iterator as dual ported RAM.

It is may be useful for previous execution cycles to store data across execution cycles for future execution cycles. Iterators can be used for this purpose. Such iterators would not require the circuitry used for communicating with the data pipe.

Certain preferred embodiments of the present invention include look up table circuits, or look up tables. Various digital math algorithms such as Newton-Raphson iterations, Radix-4 and higher SRT division, etc. use lookup tables as an integral part of the circuit. To this end, sufficient lookup tables can be provided in the RLU.

Wallace tree reductions can be effectively performed in certain preferred embodiments of the present invention. As a partial product generation and the Wallace tree reduction step in a multiply may determine the maximum of pipelined performance in a loop, these connections could be optimized with their own single hop connection scheme. Direct addressing of groups of muxes for the following multiply sizes could be implemented according to the method of the present invention: 8 bits signed and unsigned, 16 bits signed and unsigned, 24 bits unsigned (for 32-bit IEE-754 floating point multiplies), 32 bits signed and unsigned, 54 bits signed (for 64-bit IEEE-754 floating point multiplies), and 114 bits signed (for 128 bit IEEE-754 floating point multiplies). These approaches may be advantageous when doing digital math because the connections will be faster and the instructions that create them will be smaller.

The present invention may optionally comprise a circuit designed into the RLU that ignores signal transitions for a certain period of time. After this period of time has passed, a low signal on the output signals to the instruction and data pipes that the execution cycle has completed. This invented aspect of the present invention allows valuable software programming techniques based on statistically improved execution times to be applied in generating and executing instructions for the invented general-purpose computer. Tremendous amounts of thought have gone into software algorithms that are optimized for more frequent cases at the expense of less frequent cases. These algorithms can now be applied to the instructions developed according to the method of the present invention. Furthermore, optimizing the algorithm towards the most frequent cases is a valuable software engineering technique The method of the present invention optionally enables programmers to apply this method in either individual or multiple instructions generated for execution by the invented general-purpose computer.

In an example implementation, a clocked active low enable (/ENA) would run into a NOR gate along with the active low signal representing whether the circuit was done or not (/DONE). The /DONE signal would have to be stable by the time /ENA went low. Several decision points in the code could be examined in this way, each with different /ENA signals guaranteeing their stability. Their results could be ORed together to get an overall signal requesting the end of the execution cycle.

The method of the present invention further optionally enables a novel and inventive method of executing loops and/or decision trees. It is this realization: if your instructions are as large as instructions may be in certain alternate preferred embodiments of the invented general purpose computer, certain operational features critical for the efficiency for conventional microprocessors, e.g. branches, dwindle in importance. Thus the penalty for loading logic that would have been skippable by a conventional microprocessor gets small compared to the advantage received by all logic executing once it is loaded.

The fine structure of conventional microprocessor code contains many conditional evaluations and branches However, the actual logic embodied by any given high level language rarely contains raw branches. In fact it is considered bad programming practice to use them and good programming practice to avoid them. Instead, other safer logical structures such as loops, “if” statements, and “case” statements serve similar functions. In the case of loops, unless they are never executed, loading them doesn't waste code space. A smart RCPC compiler can align loops into instructions whenever possible to minimize the size of the loop instruction and provide space to unroll the loop if possible. In the case of “if” statements and “case” statements, the compiler may evaluate whether the software code inside a given block is large enough to warrant its own instruction or instructions. If so the instant code may be a candidate for conditional instruction execution. If the instant code is smaller, the amount of logic that can be rolled into a single instruction that is so large that there is not much of a penalty if some of the instruction is not actually used.

Certain alternate preferred embodiments of the present invention accept configuration data resulting from the data processing or data transmission of computational or logic elements of the invented general-purpose computer, the RLU, or the data pipepipe or data pipe. These data configurations may be used to configure the invented general-purpose computer.

The method of the present invention further optionally enables a designer of a preferred embodiment of the present invention to lay-out pluralities or multiplicities of logic elements, e.g. muxes, cones, iterators, and look up tables, and signal interconnection pathways among the pluralities or multiplicities of logic elements quantities and patterns that provide effective execution of particular digital mathematics operations, to include, but not limited to, partial product calculations and Wallace tree reductions. This optional aspect of the method of the present invention can empower a software designer, a software engineer, a software compiler designer, and/or a compiler to leverage an understanding of the configurability and reconfigurability of the invented general purpose computer to apply software engineering methods in configuring and/or using the present invention, and particularly the RLU and the data pipe in efficient patterns.

The method of the present invention further enables the optional, novel and inventive technique of enabling input of instructions to the invented general purpose computer from an off-chip or external RAM by time for width multiplexing of data from the RAM and to the instruction bus. Because modern RAM is about four times slower than modern microprocessor cores, e.g. about 400 MHz for RAM versus about 1.6 GHz for microprocessor cores, it can be useful to employ time for width multiplexing between these two circuits. This allows for a wider effective bus to the microprocessor (e.g., by a factor of four) for a given microprocessor pin count. If it desirable to use cheaper RAM, or if microprocessor cores can get easily faster, one can produce an even higher speedup by providing a larger multiplexing factor. Current memories run at about 400 MHz (2.5 nS cycle time) in row access mode. When conventionally addressed they are slower. Clearly row access should be used whenever possible with truly random access possible but used only as a last resort. Most modern bus sizes are about 64 bits wide. This gives a theoretical throughput of approximately 3 gigabytes per second. The highest pin counts for integrated circuits are in the 1,600 pin range. To stay manageable one could use 512 pins for data I/O. This alone would provide a factor of eight speed increase over most current commercial microprocessor ICs.

The following signal descriptions describe an example implementation in accordance with the method of the present invention that would convert an eight-bit bus to a 32-bit bus:

UCLK: This clock would be driven by the microprocessor during writes and the multiplexer during reads. It makes signals across the microprocessor side of the bus impervious to skew;

R/W: This signal tells the multiplexer whether the microprocessor wants to read or write during the next operation;

UDx: Eight bi-directional data bus signals between the microprocessor and the multiplexer;

A/D: This signal tells the multiplexer whether the microprocessor is sending an address or data;

/RD: Read line to memory;

/WR: Write line to memory;

Ax: 32 address lines to memory; and

MDx: 32 bidirectional data lines to memory.

The method of the present invention further provides an optional technique of logic dependent instruction execution, wherein, based on a result derived by the RLU, the instruction pipe might decide to continue executing the current instruction or execute a next and loaded instruction. This optional invented technique provides that an instruction need not be loaded before the start of execution, and avoid bottlenecking of a loop by instruction loading. Because new instructions need not be fetched during a loop of sufficiently small size, the incidence of delays in loop execution caused by instruction loading may be reduced. In a preferred and inventive application of this optional aspect of the method of the present invention, at or shortly after the time each instruction execution cycle completes, the instruction pipe looks at a flag bit from the RLU to determine whether to release the back instruction into the front buffers.

The method of the present invention further provides an optional technique of logic dependent instruction fetching, wherein, on the basis of a signal produced as a result from data processing by the RLU, the instruction pipeinstruction pipe, instruction pipe, might decide to start fetching a particular instruction from two or a plurality of instructions for loading into the back buffer. It would sometimes be useful if this signal and its associated data were available before the end of instruction execution, as it would be efficient to overlap the loading of the new instruction with a current instruction execution. It is also likely that the current instruction could continue to do useful work after the invented general-purpose computer had determined that a new instruction needed to be loaded. Stored instructions may already exist in an optional plurality of back buffers of the invented general-purpose computer. These stored instructions could be valid, executable “bubble filling” instructions or they might be flushed. The signal should also indicate how existing instructions should be handled. Certain alternate preferred embodiments of the present invention that include this optional invented technique may reduce unnecessary processing activity by not executing instructions that won't yield valuable results. In one example application of the optional, novel and invented technique of logic

dependent instruction execution, the invented general-purpose computer can provide a logic signal that is enabled from a timed clock circuit at some point during the execution (see logic dependent instruction execution times above). Along with this would be dedicated registers containing the address of the instruction to load and flag bits indicating what to do with the currently loaded instructions.

The method of the present invention further provides an optional technique of instruction swapping, wherein the invented general purpose computer, based on a result from the data processing activity of the RLU, the instruction pipeinstruction pipe can be commanded to swap a foreground instruction with a background instruction during the next execution cycle. This optional, novel and invented technique of instruction swapping can provide the present invention with an ability to swap instructions and prevent unnecessary reloading during large loops. An preferred embodiment of the invented technique of instruction swapping may include the following steps:

A) An instruction A is loaded from the back buffer to the front buffer and begins executing;

B) Meanwhile, an instruction B is loaded into the back buffer;

C) After some delay but still during execution, instruction A is copied into a side buffer;

D) The execution cycle for instruction A ends;

E) Instruction B is loaded from the back buffer to the front buffer and begins executing;

F) If a swap is indicated, instruction A is loaded from the side buffer into the back buffer; and

G) After the side buffer to back buffer load is safely complete, instruction B is copied into the side buffer.

The method of the present invention further enables an optional clock to width multiplexing of data from the invented general-purpose computer and to external and/or off-chip RAM. Because modern RAM is about four times slower than modern microprocessor cores (about 400 MHz for RAM versus about 1.6 GHz for microprocessor cores) it is useful to employ time for width multiplexing between these two circuits. This allows for a wider effective bus to the microprocessor by a factor of four for a given microprocessor pin count. If it desirable to use cheaper RAM or if microprocessor cores can get easily faster, a designer can provide even more of a speedup by providing a higher multiplexing factor. Current memories run at about 400 MHz (2.5 nS cycle time) in row access mode. When conventionally addressed they are slower,(.g., some run about 10 nS cycle time). Clearly row access should be used whenever possible with truly random access possible but used only as a last resort. Most modern bus sizes are 64 bits wide. This gives a theoretical throughput of about 3 gigabytes per second. The following signal descriptions describe an example implementation in accordance with the method of the present invention that would enable the optional clock to width multiplexing of data from the invented general purpose computer and to external and/or off-chip RAM and convert an eight-bit bus to a 32-bit bus:

UCLK: This clock would be driven by the microprocessor during writes and the multiplexer during reads. It makes signals across the microprocessor side of the bus impervious to skew;

R/W: This signal tells the multiplexer whether the microprocessor wants to read or write during the next operation;

UDx: Eight bidirectional data bus signals between the microprocessor and the multiplexer;

A/D: This signal tells the multiplexer whether the microprocessor is sending an address or data;

/RD: Read line to memory;

/WR: Write line to memory;

Ax: 32 address lines to memory; and

MDx: 32 data lines to memory.

The method of the present invention further provides an optional inclusion of multiple data busses with the invented general-purpose computer. In a preferred embodiment of this optional aspect of the present invention, the designer might split a 512 bit, or however wide, data bus, or data pipe, up into separate busses, each bus having their own separate memory areas. 64 data busses each 8 bits wide might be an effective design in certain alternate preferred embodiments of the present invention that include this optional circuitry. The compiler might place data in these different spaces for optimal row performance from the processor. Better row access may thereby be enabled, when the compiler and operating system can manage the spaces effectively. In certain preferred embodiments of the present invention, each bus could address its own space, other memory spaces, the instruction space, and other processor spaces. For example, bus zero addresses 2\hat{ }32 32 bit numbers. Dividing that space into 128 sections gives 128 megabytes per section. The use of 64 of those sections for the 64 main memory spaces might be enabled. The use several spaces to address instruction RAM to load it or modify it might be enabled. The use of a space for addressing other processors in a multiprocessor configuration might be enabled. The use of one or more spaces for memory-mapped peripherals might be enabled. The use of one space for boot purposes might be enabled. The designer of a general purpose computer created in accordance with the method of the present invention might further split these spaces address-wise so that one can be loading some areas of memory while the processor is operating on other areas. For example, one could split the space up into even and odd megabytes so that one could load even megabytes with data using a blitter while the processor is using data in odd megabytes.

The method of the present invention further provides an optional technique of variable instruction execution times, wherein the compiler can build logic circuits with a wide variety of settling times. As such, the compiler may have a method for calculating safe settling times for the circuits it creates. This information is then transmitted as part of a memory directive instruction.

In certain still alternate preferred embodiments of the present invention, the instruction decompression circuit 20 may optionally or alternatively include hardwired logic circuits, reprogrammable logic circuits, or a combination of hardwired logic and reprogrammable logic circuits. Hardwired logic circuits elements of the decompression circuit 20 allow a compiler designer to rely upon the existence of decompression circuit 20s that comply with particular decompression techniques and applied algorithm standards as specified by the architect of the integrated circuit computing device. Alternatively, the existence of reprogrammable logic circuits within the decompression circuit 20 may enable the operating system/compiler designer to reprogrammably form logic structures in the decompression circuit 20 according to algorithmic decompression methods chosen by the operating system/compiler designer.

Certain alternate preferred embodiments of the present invention may comprise two or more parallel decompression circuit 20s, wherein each separate decompression engine may simultaneously decompress an instruction or a portion of an instruction. The portion of the instruction proceeds by a parallel decompression circuit 20 may be of fixed and/or variable length in various alternate preferred embodiments of the present invention.

Certain yet alternate preferred embodiments of the invented general-purpose computer, or invented processor, include the capability to cache compressed instructions prior to decompression by the decompression circuit 20 of the instruction pipe. This optional capability may reduce inefficiencies caused by introducing latencies while compressed instructions are being loaded from outside of the present invention.

The method of the present invention further optionally includes multiple instruction buffers 22, wherein instructions are stored after processing or decompression by the instruction pipe prior to execution by the RLU. The invented general-purpose computer thereby decompresses instructions while the RLU is executing a previously decompressed or processed instruction. When more than one decompressed instruction has been stored, the invented general purpose may than choose to ignore an instruction that the present invention has determined is not to be executed, thereby reducing wasted RLU configuring and/or execution activity. The instruction pipe may be double or multiply buffered to enable data for a next instruction to be prepared or decompressed while data from a current instruction is executing.

The method of the present invention further optionally enables the invented general purpose computer to have pluralities or multiplicities of logic elements, e.g. muxes, cones, iterators and look up tables, that are simultaneously addressable and configurable in blocks of programming addresses above and/or below a signaled programming address, whereby a plurality or multiplicity of logic elements may be simultaneously interconnected with other logic elements and/or configured internally. This optional capability allows, in one possible implementation, an ability to simultaneously configure a plurality of logic elements having programming addresses between a signaled programming address and a previously established programming address, e.g. between programming addresses 1,000 and 2,000.

The data pipe or data bus may be double or multiply buffered to enable data for a next instruction to be prepared while data from a previous instruction execution is stored within the invented general-purpose computer or written to a memory element outside of the present invention.

In certain yet alternate preferred embodiments of the present invention, the instructions received by the instruction pipe may direct the operation of the data pipe by commanding the order or location of storage of data within the data pipe, or alternatively or additionally by controlling the selection and presentation of data by the data pipe and to the reprogrammable logic unit. This optional ability of the instruction to control the flow and storage of data within and/or from the data pipe may further allow the instructions to use the data pipe to support the rapid execution of iterative or sequential processing steps of the reprogrammable logic unit. Alternatively or additionally, the reprogrammable logic unit may affect its own programming by directing the operation of the instruction pipe or the data pipe as a results of computations internal to the reprogrammable logic unit.

Certain alternate preferred embodiments of the present invention comprise a separate instruction-to-data pipe bus that communicates instructions to the data pipe from outside of the present invention wherein the operation of the data pipe is directed. Instructions received by the data pipe via the separate instruction-to-data pipe bus may optionally and simultaneously, or alternatively, command the data pipe to (1) load data for upcoming instructions, (2) command the data pipe to load data for future execution cycles, or store data resulting from or related to earlier execution cycles, (3) control execution or fetching of instructions, and/or (4) perform other suitable actions known in the art.

The method of the present invention optionally comprises an interrupt service function, wherein the operation of the invented general purpose computer is affected by inputs or signals received from external sources, such as a mouse, a keyboard or other suitable devices, channels or hardware peripherals known in the art.

Preferred embodiments of the present invention may be made of suitable materials known in the art of computational apparatus and system design, including but not limited to electronic, optical, mechanical, pneumatic, hydraulic, atomic, subatomic, biological, neural, gravitational, magnetic, and/or electromagnetic materials or components. Certain alternate preferred embodiments of the present invention comprise semiconductor materials such as Silicon or Gallium Arsenide, or other suitable semiconductor materials known in the art, in singularity or in combination. Certain alternate preferred embodiments of the present invention may alternatively or additionally include individual or mixtures of suitable materials known in the art of electronic, neural, biological and/or optical circuit manufacture. More particularly, the preferred embodiment may include suitable dopants, metallization materials, gas deposition materials and/or sputtered material known in the art of logic or microprocessor circuit manufacture.

In operation, the preferred embodiment of the present invention, or preferred embodiment, accepts a single uncompressed or decompressed instruction, or a set of instructions that may individually be uncompressed or partially or wholly compressed instructions, through the instruction bus, or alternatively through a shared instructions and data bus. The integrated circuit computing device, or invented processor, then processes the compressed instructions through the decompression circuit 20. The decompression circuit 20 then transmits the decompressed instruction bus to the reprogrammable logic unit. The reprogrammable logic unit then modifies and establishes connections between and among part or all of the functional circuits of the reprogrammable logic unit. The data pipe may make data available to the reprogrammable logic unit. The reprogrammable logic unit may then wait for the passing of a specified or required settling time period or latency time period. The invented processor executes an instruction cycle after the reprogrammable logic unit is programmed and/or reprogrammed in accordance with the directions contained within the uncompressed or decompressed instruction or instructions that have been transmitted via the instruction bus, instruction pipe and optionally the decompression circuit 20. The preferred embodiment further provides that instructions received by the instruction pipe may be transmitted to the data pipe and may direct the ordering of data within the data pipe and/or control the sequence, pathway or method of presentation and transmission of data from the data pipe to the reprogrammable logic unit or elsewhere within, to or from the invented processor.

The software compiler of the preferred embodiment may accept a source code program written in a higher-level software language, such as JAVA, or another suitable software language known in the art. The software compiler of the preferred embodiment or compiler, may analyze or deconstruct the source code program in order to generate a set of instructions that may efficiently program the invented processor. The compiler may analyze the executable acts or logical steps that the invented processor shall perform in order to cause the invented processor to produce the results or behavior desired by the source code program. The compiler may maintain a software model of the invented processor and/or logical states and interconnect assignments of the reprogrammable logic unit, the functional devices of the reprogrammable units, and other elements of the invented processor. The compiler may reference the software model to determine which elements of the invented processor may have been configured, programmed or reprogrammed in a potential or required instruction cycle or other time period. The compiler may use the software model of the invented system to fully or partially analyze the logical sequences directed by the source code in order to establish a set of instructions that may efficiently program or reprogram elements of the invented processor, such as the functional circuits of the reprogrammable logic unit. The compiler may generate a set of instructions that are designed to support the rapid execution of the set of instructions by efficiently programming and reprogramming the functional circuits of the reprogrammable logic units so that the number of instructions required to be provided to the invented processor is reduced. The compiler may additionally or alternatively generate a set of instructions that reduce a total execution time required for the invented processor to produce the behavior or results directed by the source code. The compiler may additionally or alternatively generate a set of instructions that reduce the length of a time period required for the invented processor to produce the behavior or results directed by a segment of the source code. By way of example, suppose that a particular complex logical sequence is required to be performed numerous times by the reprogrammable logic unit. The compiler may derive, from an analysis of the source and the software model of the invented processor, that a certain group of functional logic circuits, that might include muxes, cones, look up tables and iterators, may be programmed and reprogrammably interconnected together to perform the instant complex logical sequence, and that an execution time advantage results when this group of functional logic circuit is maintained and available for repeated use by the invented processor. In this example, the invented processor may reduce the number of instructions and/or the reduce the length of certain instructions that are sent to the instruction pipe. This reduction in instruction count and/or the length of certain instructions may provide execution efficiencies by reducing the time required to transmit a set of instructions to the instruction pipe and/or reducing the time required to program or reprogram the invented processor, the reprogrammable logic unit or other elements of the invented processor, such as the decompression circuit or the data pipe. The compiler may also consider the sequence, or alternative sequences, of logical processes that may be executed in order to satisfy the dictates of the source code. The compiler may, for example, elect to reprogrammably connect or configure selected functional logic circuits in certain patterns and sequences in order to streamline and make more efficient a set of instructions, where the invented executes the set of instructions in accordance with the required behavior and results of the source code. The compiler determined patterns and sequences of reprogrammable connections or interconnections of the functional logic circuits, and/or other elements of the invented processor, may be selected to increase or optimize the speed with which the invented processor executes a single instruction, a partial set of instructions, or a set instructions.

The method of the present invention enables the design and use of a compiler that can elect to create two or a plurality of functionally equivalent instructions, wherein a first alternate instruction may be pipelined in the RLU over several execution cycles, and a second alternate instruction would execute in a single instruction cycle. The complier may determine which alternate instruction, from between the first and second alternate instructions, or from a plurality of alternate instructions, more or most efficiently drives the operation of the present invention, and thereupon create the more or most efficient instruction. The determination of the efficiencies or relative efficiencies of the alternate instructions may, in certain preferred embodiments of the method of the present invention, be made without or before generating any alternate instruction.

The method of the present invention enables the design and use of a complier that may examine source code that describes repetitive logic, or mathematical actions or cycles, such as the C programming language commands FOR, WHILE or DO commands can define, and therefrom derive and generate effective loop instructions executable by the present invention. An effective loop instruction may include several iterations of, or several portions of an iteration or iterations of, one or more loop actions or cycles.

The method of the present invention optionally further comprises the generation and/or execution of software code that may embody design methods employed by digital logic circuit designers, such as employing Wallace tree reductions to reduce several addition operations to a single addition operation, and other suitable digital circuit design methods known in the art.

Alternate preferred embodiments of the present invention may implemented with suitable semiconductor device materials known in the art and using complementary metal oxide substrate, or CMOS, structures, or emitter coupled logic, or ECL, or transistor to transistor logic, or TTL, or another suitable electronic circuit materials and structures known in the art. Still alternate preferred embodiments of the present invention may include suitable materials known in the art of logical device design, including but not limited to quantum physics phenomena and/or electronic, electrical, optical, magnetic, electromagnetic, biological, neural, molecular, atomic, and/or sub-atomic materials, components or characteristics

Certain preferred embodiments of the present invention can repeatably provide an instruction to the RLU that can generate a body of reconfigurable logic sufficient to instatiate a computing power equivalent to dozens or hundreds of of conventional von Nuemann instructions. This optional capability of communiating to the RLU via a large and sustainable bandwidth enables the confifuration of more optimized reconfigurable states of the RLU and faster reconfigurable circuits. The delivery of large instructions to the RLU via a large and sustainanble rate and bandwidth increases the magnitude of computing effected during certain, all or most clock cycles of these preferred embodiments. The transmission of larger instructions to the RLU can make possible better impression gains.

The architectural parallelism of the method of the present invention as embodied in certain alternate preferred embodiments of the present invention enable the compiler to examine the source code and identify and act on opportunities to exploit the present invention's capabilities by forming RLU instructions that more efficiently reconfigure the RLU and/or generate more computationally powerful reconfigured states within the RLU. More computation can thus be accomplished within an individual clock cycle by more intelligently packing and associating selected source code elements within better struction reconfiguration commands placed within the instructrion by the compiler.

Certain still alternate preferred embodiments of the present invention additionally or alternatively reduce the quantity of bits or information necessary to reconfigure the RLU by organizing a subset or all reconfigurable circuits of the RLU of into pluralities of associated circuits, wherein each plurality may comprise a group of circuits that are reconfigurable with one command consisting of one bit, or a few bits. This optional capability of reconfiguring a plurality of associated circuits by means of a single bit or element of the RLU instruction reduces the size of the instruction necessary to reconfigure the RLU in a given reconfiguration step.

In certain alternate preferred embodiments of the invented cone, the cone has no or little native or dedicated connectivity circuitry, but rather makes use of the connectivity circuitry of other logic circuits. This optional design feature reduces the area required for formation of a cone on the substrate or platform of the present invention.

Certain still alternate preferred embodiments of the present invention employ 8 bit words within the instruction. This optional actuation of an 8-bit architecture within these preferred embodiments may produce savings in areas of the substrate or platform of the present invention devoted to connectivity circuitry itself and/or to effectivity connectivity functions. Additionally, this optional employment of an 8-bit architecture may have a minimal or acceptable impact on the computational power capabilities of the present invention and as delivered by the muxes and iterators.

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. 1 depicts a preferred embodiment of the present invention.

FIG. 2 shows the preferred embodiment of FIG. 1 modified by eliminating separate interface circuits and providing a single, unified instruction and data bus.

FIG. 3 depicts a close view of the reprogrammable logic unit of FIG. 1.

FIG. 4 is a schematic of a preferred embodiment of a mux.

FIGS. 5A through 5N is an alternate preferred embodiment of a mux.

FIGS. 6A through 6H is a schematic diagram of a cone.

FIG. 7 is a schematic of a preferred embodiment of an iterator.

FIG. 8 depicts a program flow of a compiler that accepts source code and generates instructions for the preferred embodiment of the present invention of FIG. 1.

FIG. 9 depicts a flow chart of the configuration and execution of the invented processor of FIG. 1.

FIG. 10 is a schematic of a plurality of a preferred embodiment of a supercarry circuit.

FIG. 11 is a schematic of a preferred embodiment of the max circuit.

FIG. 12 is a schematic of a circuit having eight alternate preferred embodiments of a mux circuit.

FIG. 13 is a schematic of a one bit wide mux circuit.

FIG. 14 is a schematic comprising a preferred embodiment of a mux having a 3 byte input and a two byte output.

FIG. 15 is a schematic of a part of a preferred embodiment of an iterator circuit.

FIG. 16 is an alternate preferred embodiment of an iterator circuit.

### DETAILED DESCRIPTION OF THE PREFERRED EMBODIMENT

In describing the preferred embodiments, certain terminology will be utilized for the sake of clarity. Such terminology is intended to encompass the recited embodiment, as well as all technical equivalents which operate in a similar manner for a similar purpose to achieve a similar result.

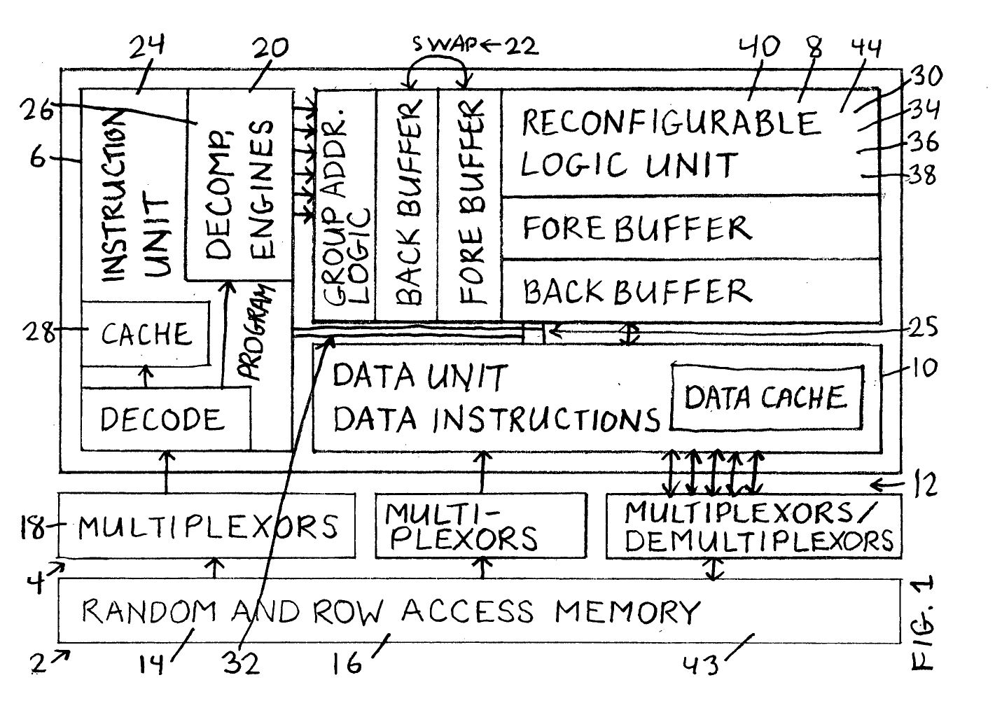

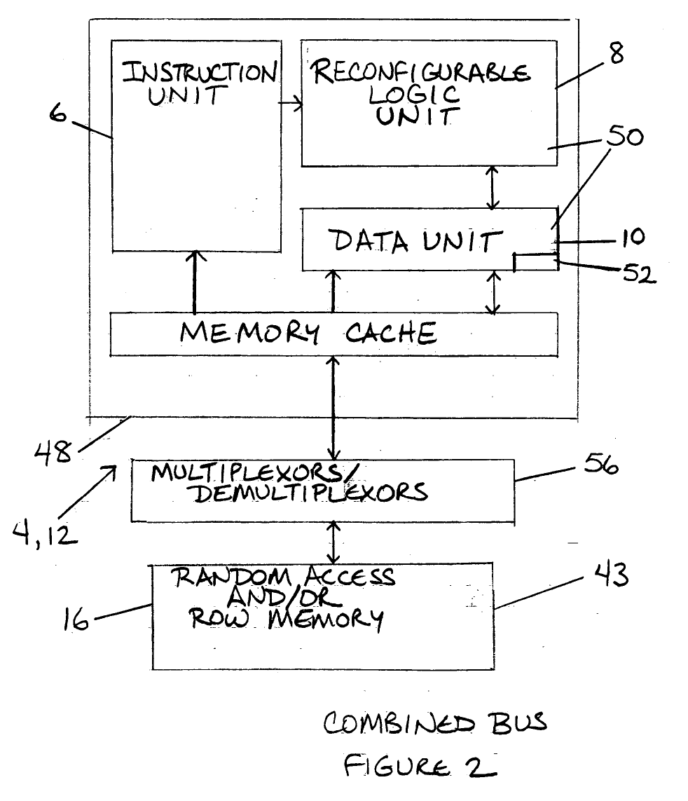

Referring now generally to the Figures and particularly to FIG. 1, a preferred embodiment of the present invention 2, or invented processor, is an integrated circuit and includes an instruction bus 4, an instruction unit or pipe 6, a reprogrammable logic unit 8, a data unit or pipe 10 and a data bus 12. The instruction bus 4 receives instructions from an instruction source 14 that is outboard of the invented processor 2. The instructions are transmitted as digital logic signals from a RAM 16 and via a clock-to-width multiplexer 18 of the instruction source and to the instruction bus 4. The instructions are then read from the instruction bus 4 and into the instruction pipe. The instruction pipe 6 collects the instructions and decompresses the received instruction in a decompression circuit 20. One, more than one, all or none of the instructions might be uncompressed and one, more than one, all or none of the instructions might be compressed. Uncompressed instructions are transmitted from the instruction pipe 6 to the reprogrammable logic unit 8, or RLU 8, decompression circuit 20 and transmitted from the instruction pipe 6 to the reprogrammable logic unit 8. Alternatively or additionally, decompressed instructions may be stored in instruction buffers 22 located within, or associated with, the instruction pipe 6 and/or the RLU 8.

The invented processor 2 can receive and respond to interrupt signals from the instruction pipe 6, the data pipe 10 and/or an interrupt circuit 24. The invented processor 2 can also elect to fetch new instructions from an external or off-chip source in response to an interrupt signal received from the same or another external or off-chip interrupt source 25, or upon the basis of data received and/or logical determinations produced by the data or logic processing of the invented processor 2 itself Compressed instructions are received by the instruction pipe 6 from the instruction bus 4 and may be immediately decompressed or may be stored in a pre-decompression cache 28. Compressed instructions may be stored in an instruction cache 26 while other instructions, such as earlier received compressed instructions, are being decompressed. The instruction pipe 6 will later elect to read a stored compressed instruction from the instruction cache 26 and then decompress and transmit the decompressed instruction to the RLU 8.

The RLU 8 may execute one instruction while substantially simultaneously receiving another instruction from the instruction pipe 6. The invented processor 2 may swap instructions by deciding, upon the base of data received and the execution of instructions, which decompressed instruction to execute from among two or more instructions stored in the instruction buffers 22. Alternatively or additionally, the invented processor 2 may swap instructions by deciding, upon the base of data received and the execution of instructions, which compressed instruction to decompress and execute from among two or more compressed instructions stored in the instruction buffers 22.

Alternatively or additionally, decompressed instructions may be stored in instruction buffers 22 in the instruction pipe 6 and/or the RLU 8. The storage of decompressed instructions in buffers 22 enables the invented processor 2 to decide among two or more possible instruction to execute, whereby the processing of the invented processor 2 is used to direct the instruction level operation of the invented processor 2 itself. As an illustrative example, the invented processor 2 may determine, on the basis of the results of previously executed commands sent to the RLU 8, that a particular instruction, that has been decompressed and stored in an instruction buffer of the instruction pipe 6, should not be executed and should be ignored and overwritten. In this case the invented processor 2 eliminates a waste of time that would have occurred by unnecessarily executing this particular decompressed instruction. Alternatively and/or additionally, the compressed instructions may be stored in the instruction buffer 22, whereby the incidence decompression of instructions that are then elected to be disregarded or ignored by the invented processor 2 is reduced or avoided.

The decompression circuit 20 contains reprogrammable logic elements 30 that accept decompression programming instructions from the instruction pipe 6 line and/or data pipe 10, whereby the decompression method of the invented processor 2 may be defined, modified or altered by the instructions and/or data transmitted to the invented processor 2 via the data bus 12 and/or instruction bus 4. This reprogrammability of the decompression circuit 20 extends the range of methods that the invented processor 2 can use in formatting, compressing, transmitting, and decompressing instructions transmitted to and from the invented processor 2. Certain instructions received by the instruction pipe 6 may control the operations of the data pipe 10. Instructions directing the storage, transmission, receipt, or movement of data or instructions stored in the data pipe 10 can be transmitted from the instruction pipe 6 via an instruction pathway 32 of the decompression circuit 20. The instruction pathway 32 may decompress an instruction received by the instruction pipe 6 in a compressed state and meant for transmission to the data pipe 10.

The decompression circuit 20 includes two or more parallel decompression circuits 20. These parallel decompression circuits 20 act substantially simultaneously and decompressed compressed instructions and/or elements or portions of instructions and substantially simultaneously transmit the resultant decompressed instructions and/or portions or elements of decompressed instructions to the RLU 8.

The reprogrammable logic unit 8 includes a plurality of functional logic circuits 34, including but not limited to muxes 36, cones 38, iterators 40 and look up tables 42. The reprogrammable logic unit 8 further comprises reprogrammable interconnects that enable the selective connection of the outputs of certain functional logic circuits 36, 37, 38, 40, & 42 to the inputs of other functional logic circuits circuits 36, 37, 38, 40, & 42. It is significant that certain functional circuits circuits 36, 37, 38, 40, & 42 may be connected such that the output of a given circuit circuits 36, 37, 38, 40, & 42 is transmitted into the input of the same given circuit circuits 36, 37, 38, 40, & 42.

In operation, the invented processor 2 may accept a set of instructions into the instruction pipe 6, and decompress and transmit the instructions to the reprogrammable logic unit 8 and optionally the data pipe 10. Data associated with the set of instructions may be accepted by the data pipe 10 from an outboard data source 43 and via the data bus 12. The invented processor 2 may then wait until the set of instructions has programmed and/or reprogrammed selected reprogrammable interconnects 44 of the reprogrammable logic unit 8. The invented processor 2 may wait for a propagation delay and a settling latency as the interconnects 44 among and between functional logic circuits circuits 36, 37, 38, 40, & 42 of the reprogrammable logic unit 8 are established and settled. The invented processor 2 may then execute an instruction cycle, whereby the reprogrammable logic unit 8 executes the programming previously received in both the most recent transmission of instructions from a communications pipeline 46 as well as the programming received by the reprogrammable logic unit 8 in programming or reprogramming actions previous to the most recent receipt of instructions. This computing sequence of programming and reprogramming the reprogrammable logic unit 8 and optionally the data pipe 10, and accepting data into the data pipe 10 from the outboard data source 43, and then executing an instruction cycle after a programming and reprogramming delay and settling latency is used to efficiently deliver a set of instructions and data to the reprogrammable logic unit 8 and to efficiently execute one, or more than one, or a set of instructions in a single instruction cycle.

In a configuration period, the RLU 8 reconfigures the interconnections among the functional logic elements circuits 36, 37, 38, 40, & 42, to include muxes 36, cones 38, iterators 40, look up tables 42, logic gates, and other suitable logic circuits known in the art. This reconfiguration may be directed by instructions and/or data received by the RLU 8 from the instruction pipe 6, the data pipe 10, and/or the interrupt source 25. In a following execution cycle, the RLU 8 executes an instruction and generates the results of digital logic processing by processing data and/or instructions generated by the invented processor 2 or by processing data and/or instructions received from the instruction pipe 6, the data pipe 10, and/or the interrupt source 25. The processing of data and/or instructions in the execution cycle is performed in accordance with the interconnections made during the configuration period and/or previous configuration periods and/or the results created by previous execution cycles.

The functional logic elements of the RLU 8, including muxes 36, cones 38, iterators 40, look-up tables 42 and/or other suitable logic circuits known in the art, are addressable in blocks and may be substantially simultaneously configured en mass. An en mass configuring of a block of functional logic elements circuits 36, 37, 38, 40, & 42 may affect the internal configuration of the functional logic elements circuits 36, 37, 38, 40, & 42 and/or the interconnections of each functional logic unit circuits 36, 37, 38, 40, & 42 to another functional logic element circuits 36, 37, 38, 40, & 42, an external device, or to the invented processor 2. A block may be designated to comprise all addresses of functional logic elements above a low threshold address and below a high threshold address, either inclusive or exclusive of the threshold addresses. The block may consist of a single type of functional logic unit circuits 36, 37, 38, 40, & 42, e.g. cones 36, muxes 38, iterators 40, look up table 42, or another suitable type of logic circuit known in the art. This capability of the invented processor 2 enables highly efficient configuring of the RLU 8 by the substantially simultaneously configuring of pluralities or multiplicities of functional logic elements circuits 36, 37, 38, 40, & 42.

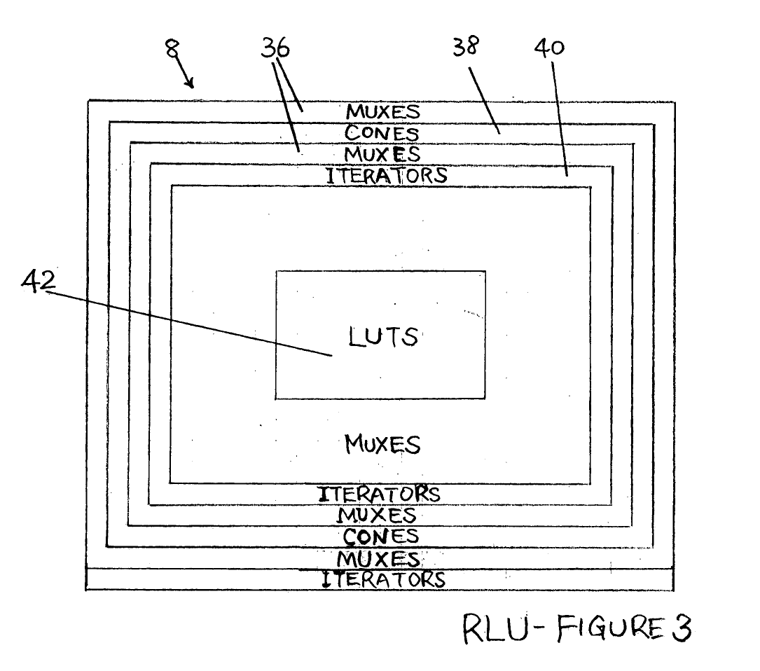

Referring now generally to the Figures and particularly to FIG. 2, the invented processor 2 of FIG. 1 is modified to have single data and instruction bus 46 through which data and instructions are transmitted to and from the invented processor 2. The separate data and instruction buses 4 & 12 of the invented processor 2 of FIG. 1 have been eliminated in the alternate modified invented processor 48 of FIG. 2.

Referring now generally to the Figures and particularly to FIG. 1, modified invented processor 48 further comprises a plurality of data buffers 50 located in the RLU 8 and the data pipe 10, multiple data bus 12es, a data pipe 10 instruction bus 4 and a data cache 52. The method of the present invention as embodied with the invented processor 2 uses a clock-to-width multiplexer to bi-directionally communicate data to and from a data interface 54 of the invented processor 2 and a RAM 16. The RAM 16 and the clock-to-width multiplexer 56 are located external to the invented processor 2.

The data buffers 54 contain data provided by the RLU 8, the instruction pipe 6, an interrupt circuit 56 and/or the data pipe 10. The RLU 8 may access the data stored in the buffers 54, or have data communicated from the buffers 54 and to functional logic elements circuits 36, 37, 38, 40, & 42 of the RLU 8. This buffering of data enables the RLU 8 to have a plurality of datum or sets of data available in anticipation of potential elections of processing steps or execution cycles of the invented processor 2. The plurality of data buffers thereby enables the invented processor 2 to operate more efficiently by making data necessary for alternate configuration steps and/or execution cycles be available to the RLU 8 substantially simultaneously.

The multiple data buses 12 bi-directionally and substantially simultaneously communicate with sources external to the RLU 8 and thereby enable the communication of larger amounts of data at faster rates than a single data bus 12 might operate.

The data cache 52 stores information, instructions or data for later access by the data pipe 10 or the modified invented processor 48. The data cache 52 enables the data pipe 10 to accept and store data received from an external source or sources 43, or the invented processor 2, while substantially simultaneously communicated with an external device or interface, with the RLU 8, with the instruction pipe 6, or with the invented processor 2.

The data pipe 10 instruction bus accepts data pipe 10 instructions from an external source and communicates the data pipe 10 instruction to the data pipe 10. The data pipe 10 then executes the instruction, whereby the data pipe 10 directs or affects the operation of itself, the RLU 8, the instruction pipe 6 and/or the invented processor 2.

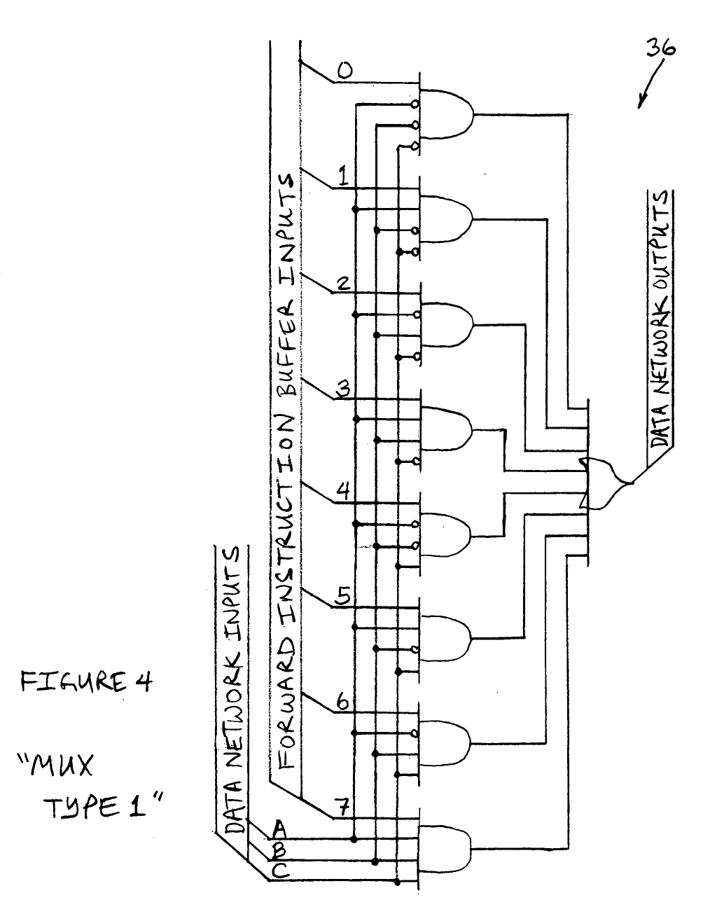

Referring now generally to the Figures and particularly to FIG. 3 the reprogrammable logic unit 8 of FIG. 1 comprise a plurality of functional logic circuits 36, 37, 38, 40, & 42, including but not limited to muxes 36, parallel carry circuits 37, cones 38, iterators 40 and look up tables 42, or LUTS 42. The functional logic circuits are configurably and/or reconfigurably interconnected and/or intraconnected. The configuration and reconfiguration of interconnections between, among and within the functional logic elements circuits 36, 37, 38, 40, & 42 may, in various alternate preferred embodiments of the present invention, be directed, initiated, released and/or modified by decompressed or uncompressed instructions transmitted to the RLU 8 solely, alternately or additionally from the instruction pipe 6, the data pipe 10 or the invented processor 2.

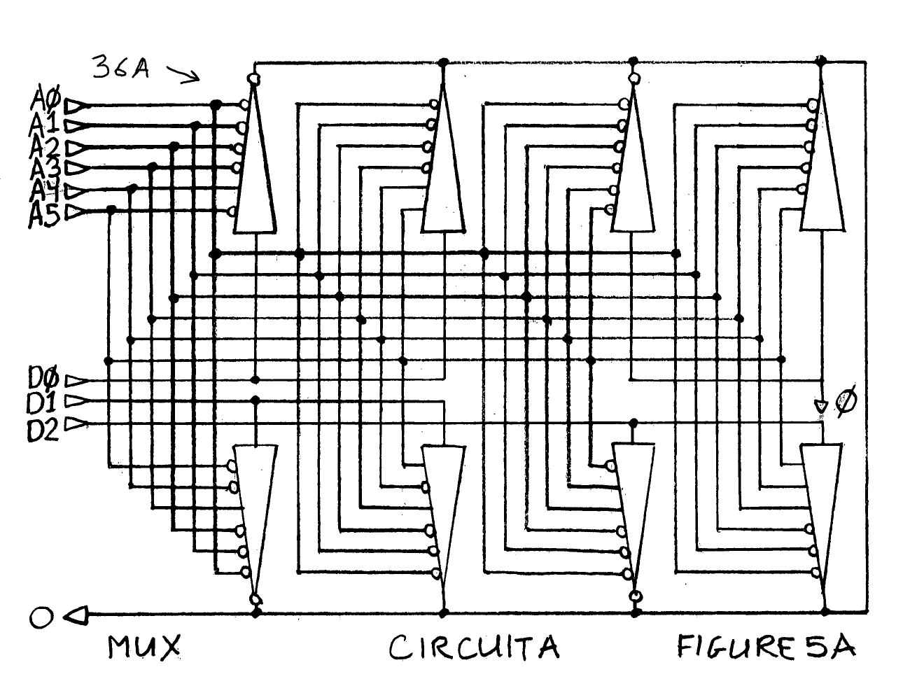

FIG. 4 is a schematic of a preferred embodiment of a mux 36.

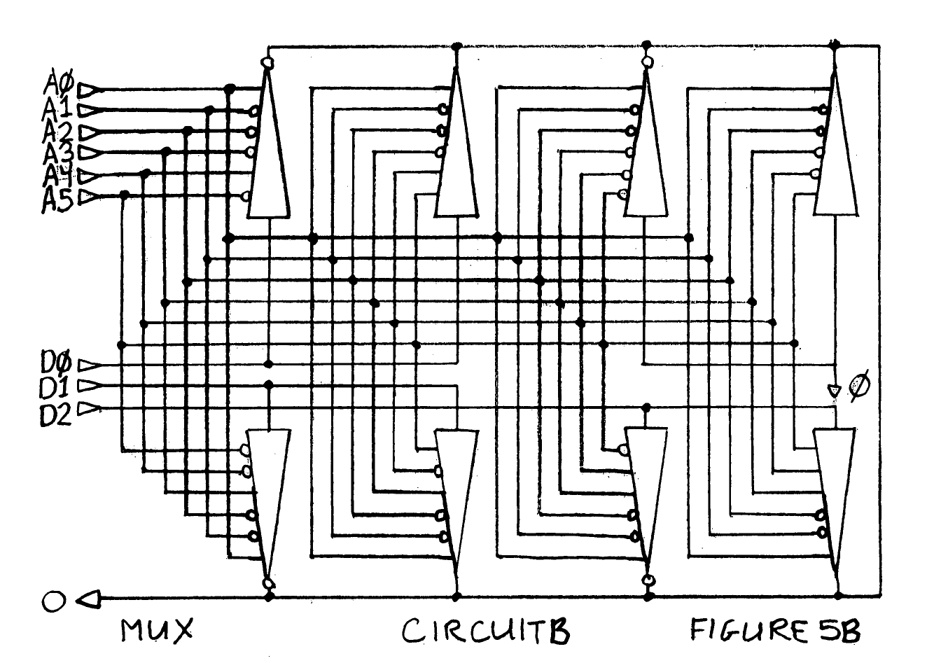

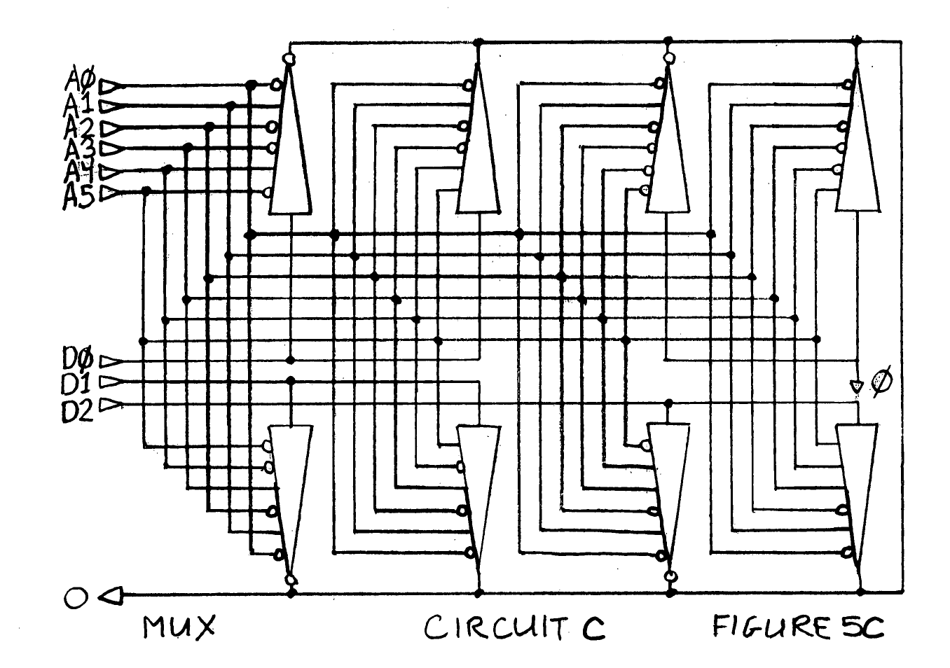

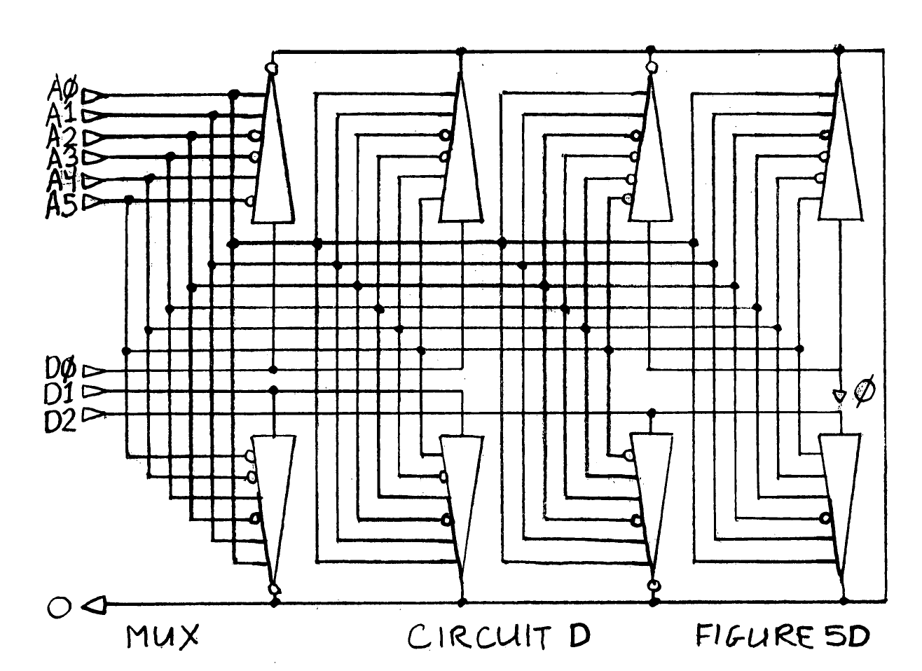

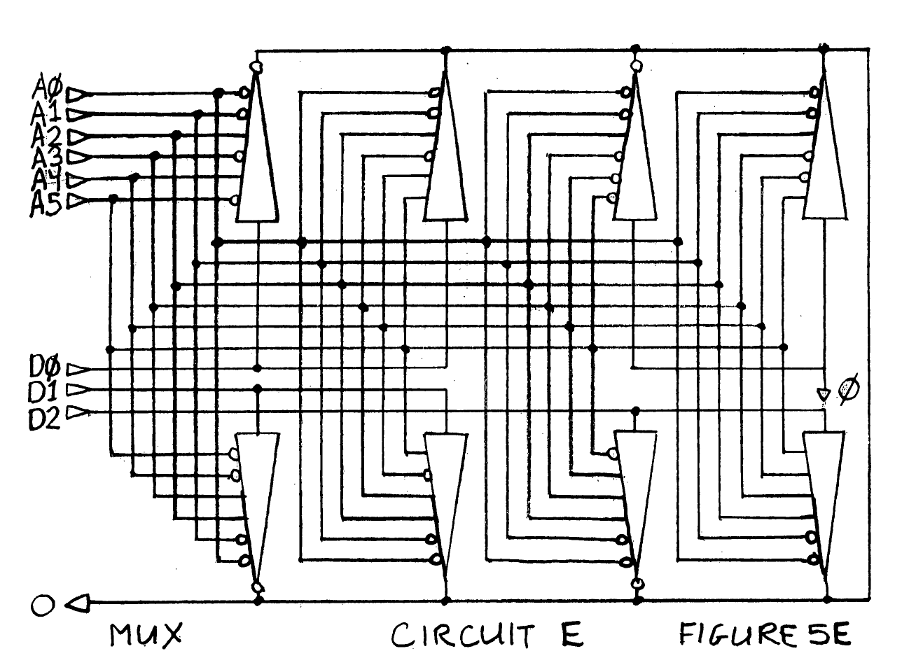

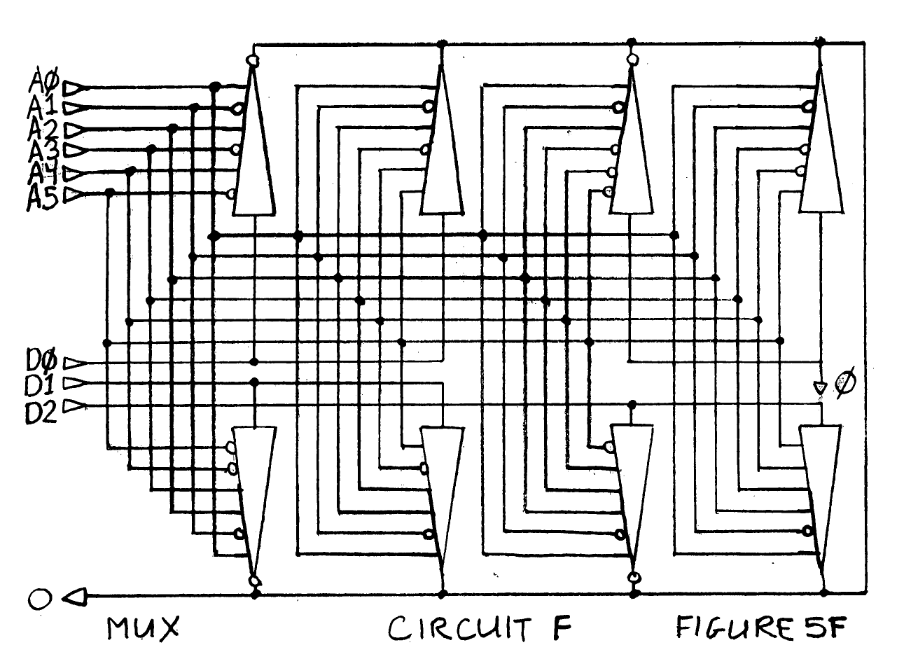

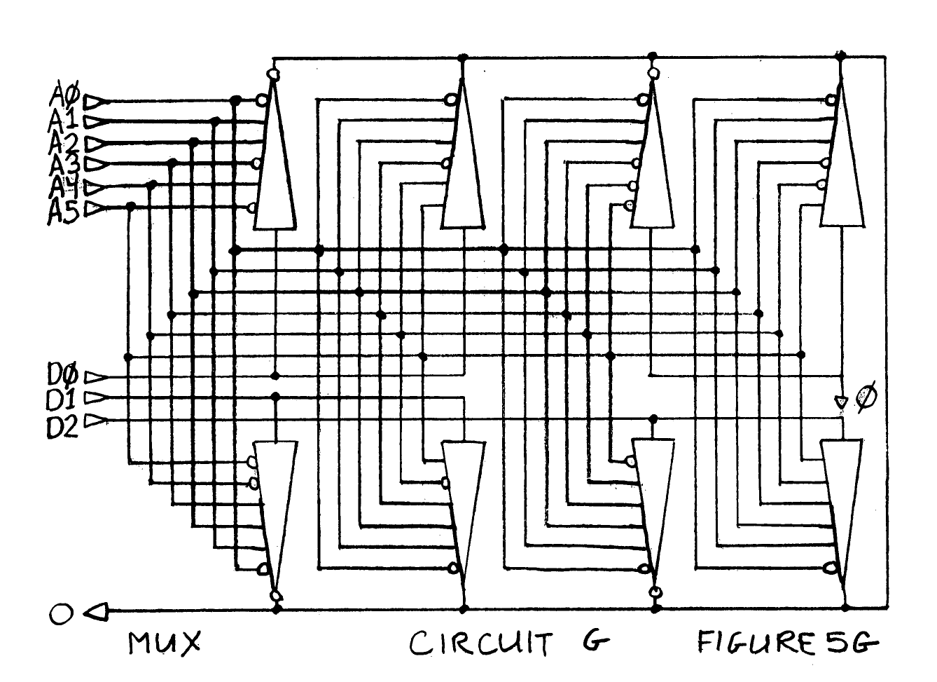

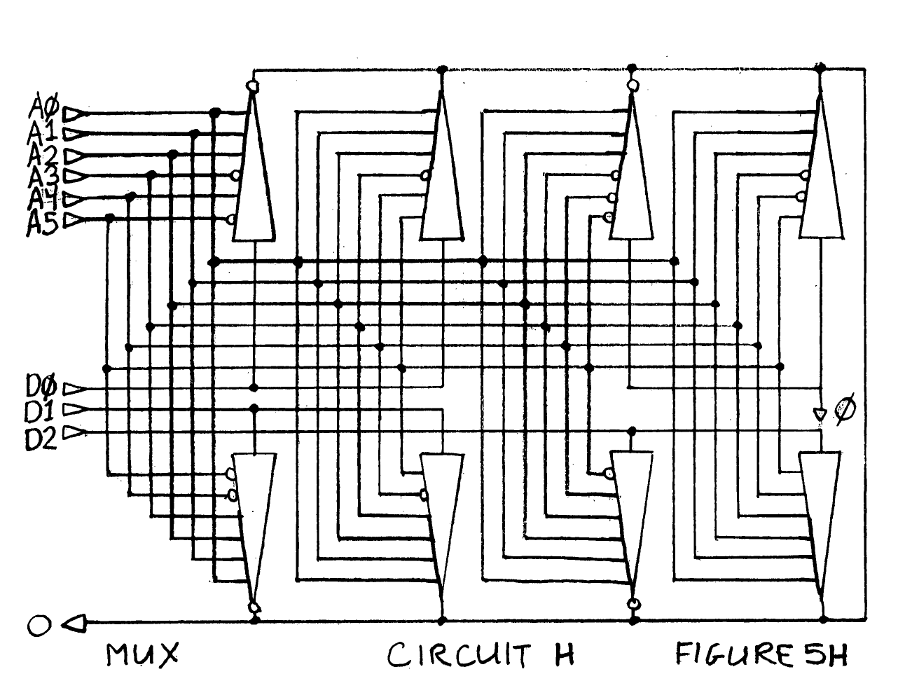

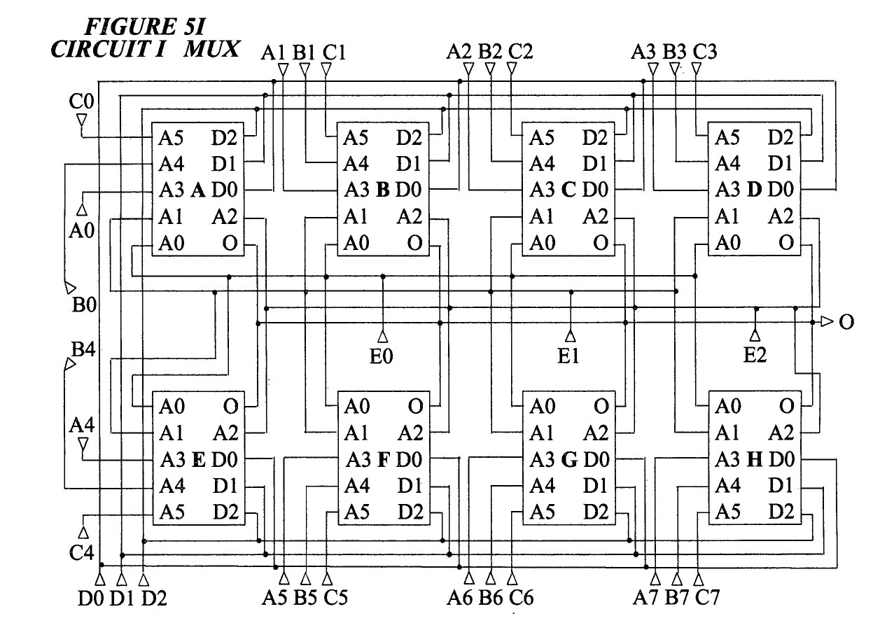

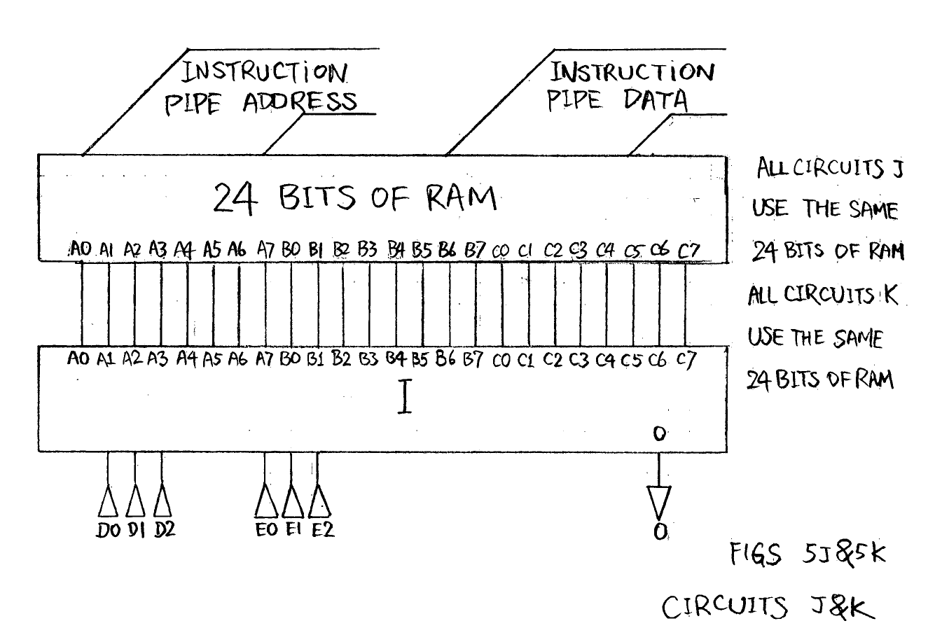

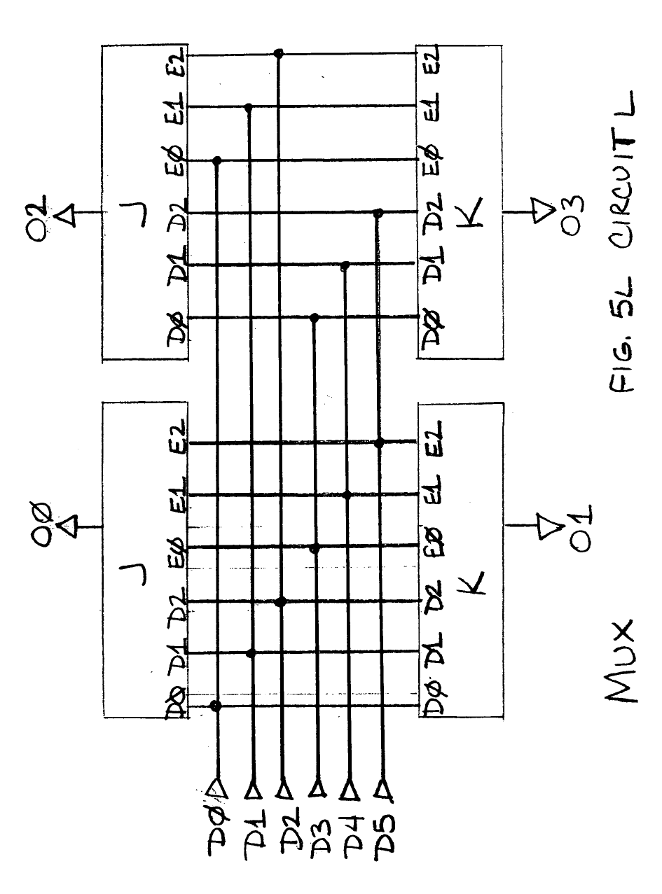

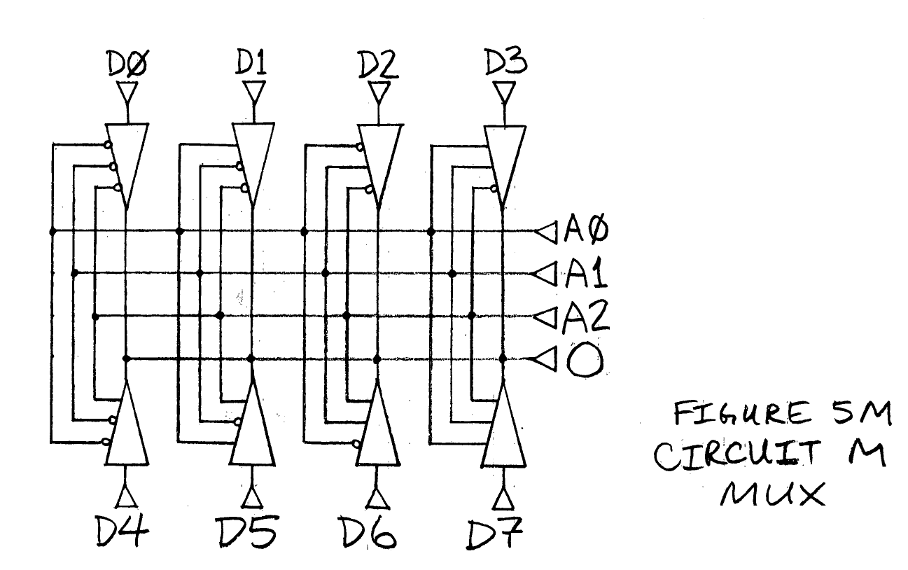

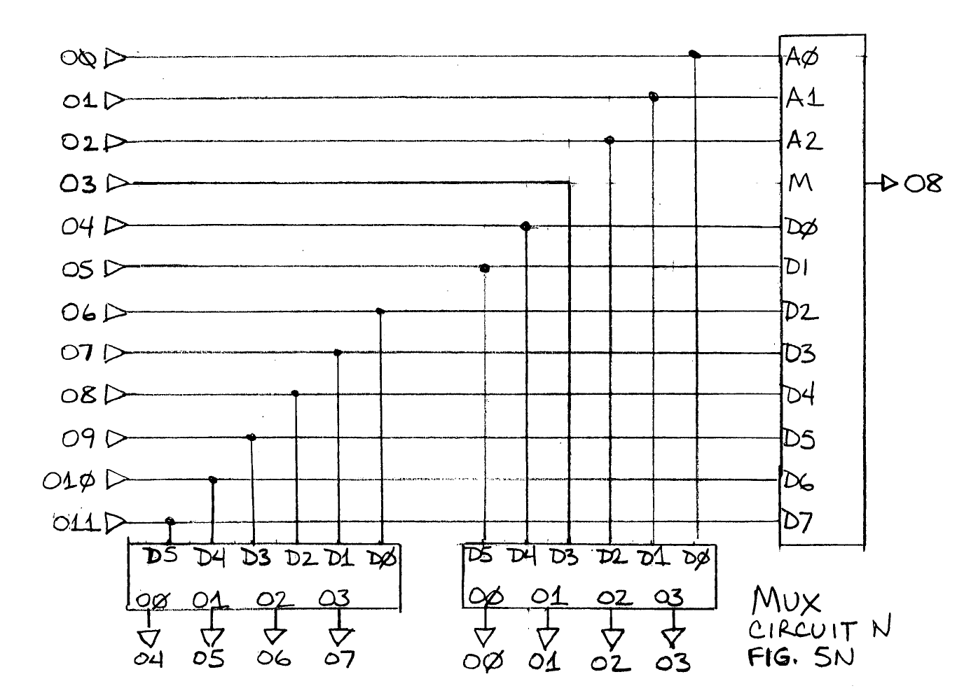

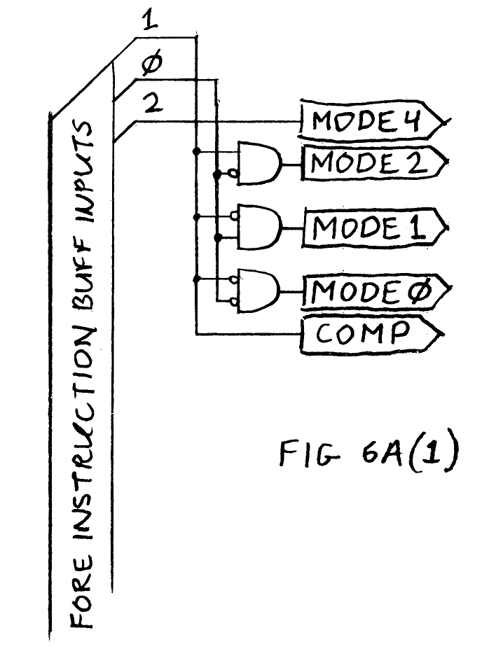

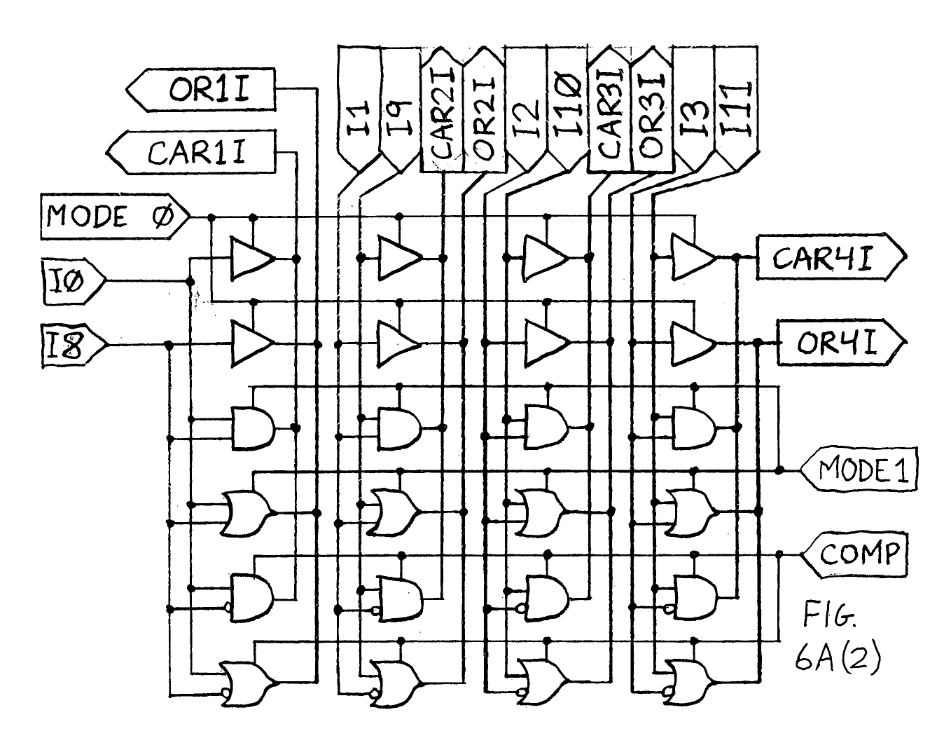

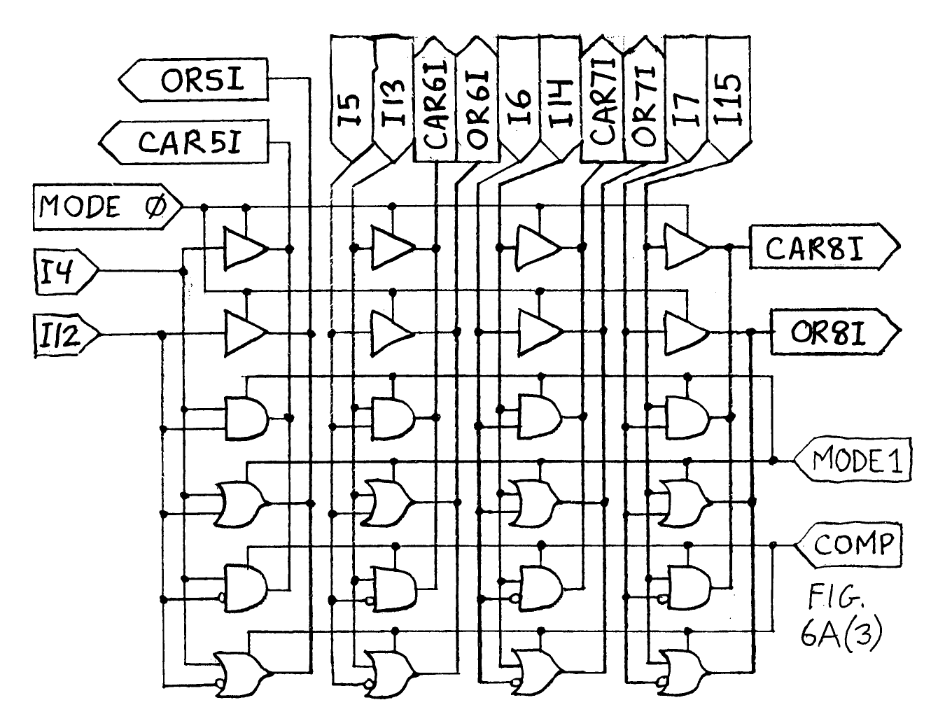

FIGS. 5A through 5N is an alternate preferred embodiment of a mux 36A.

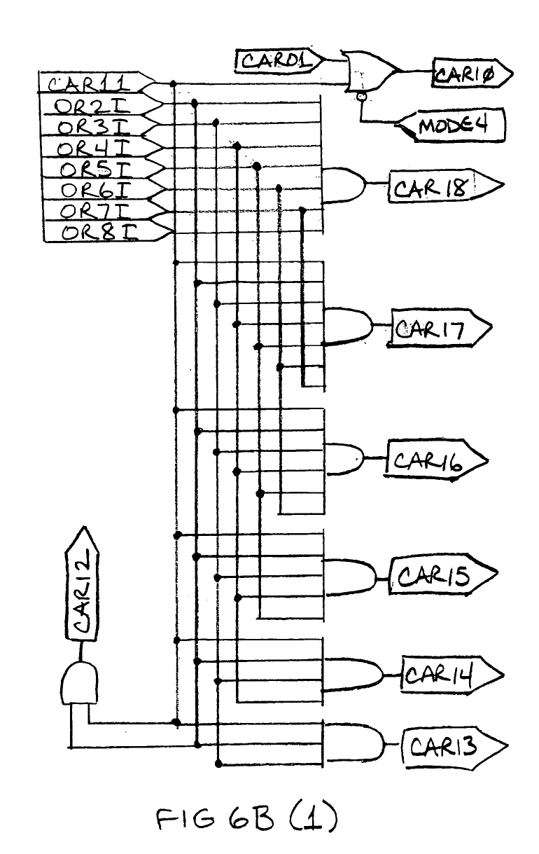

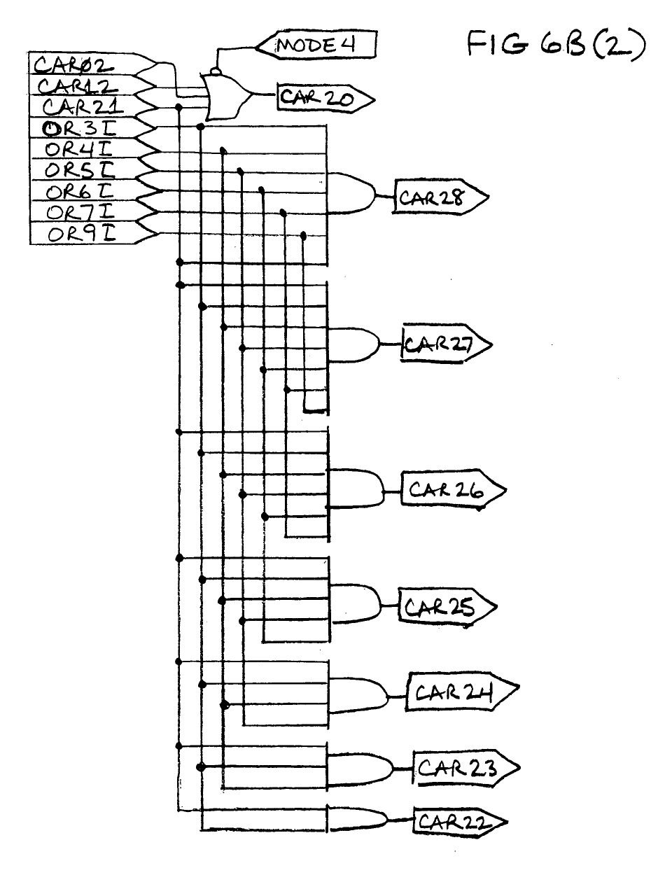

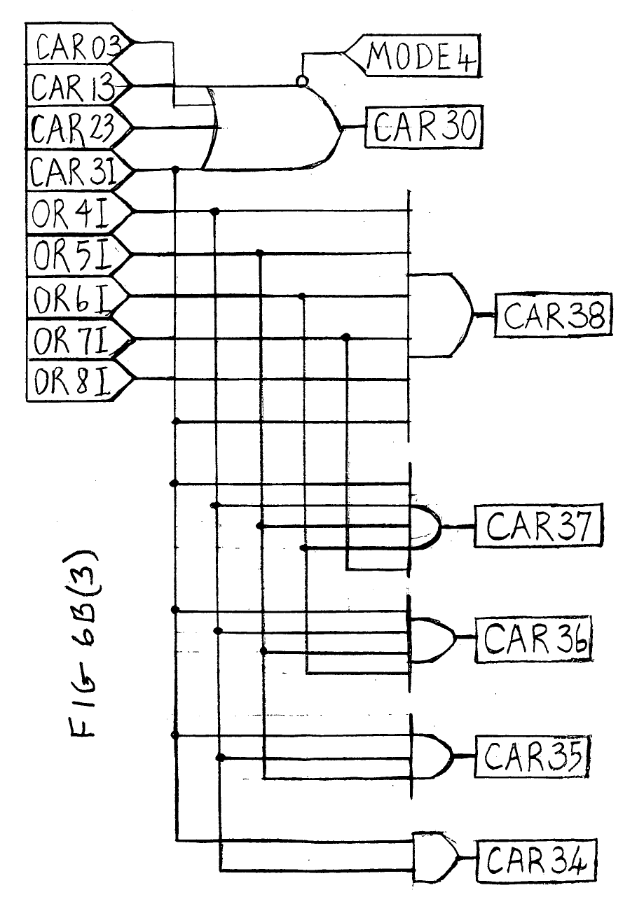

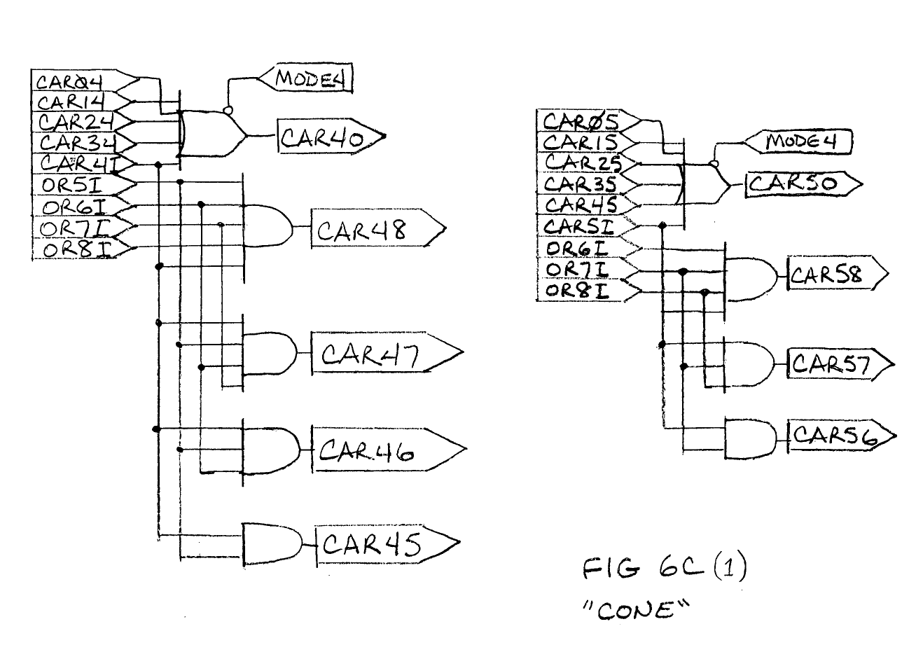

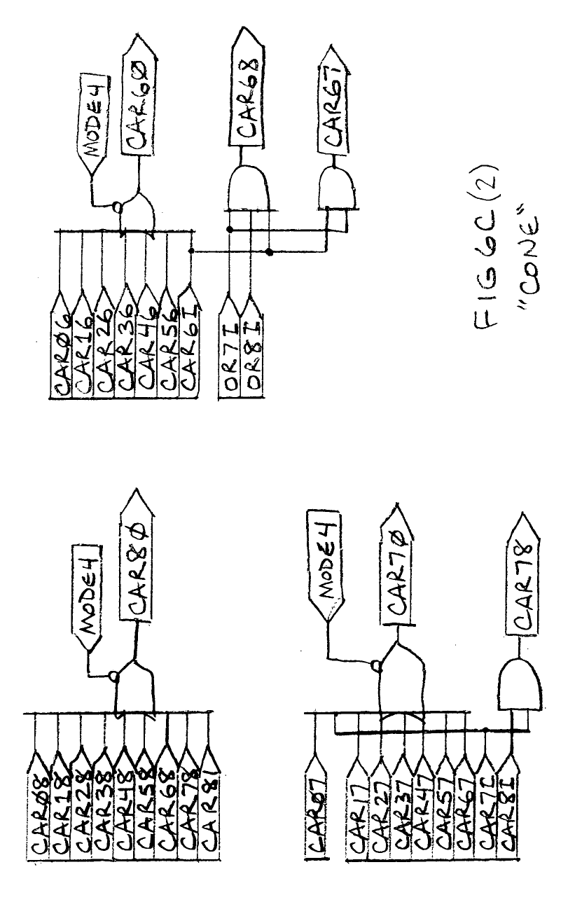

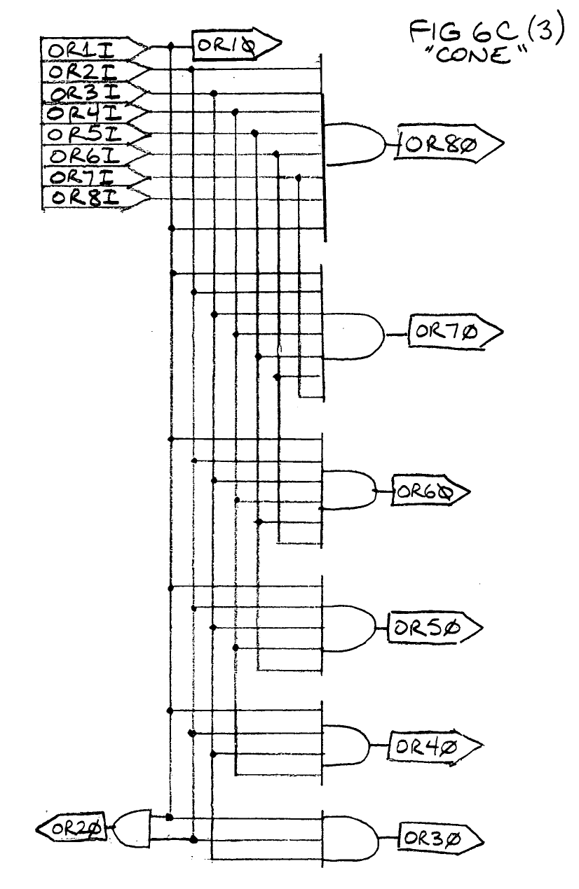

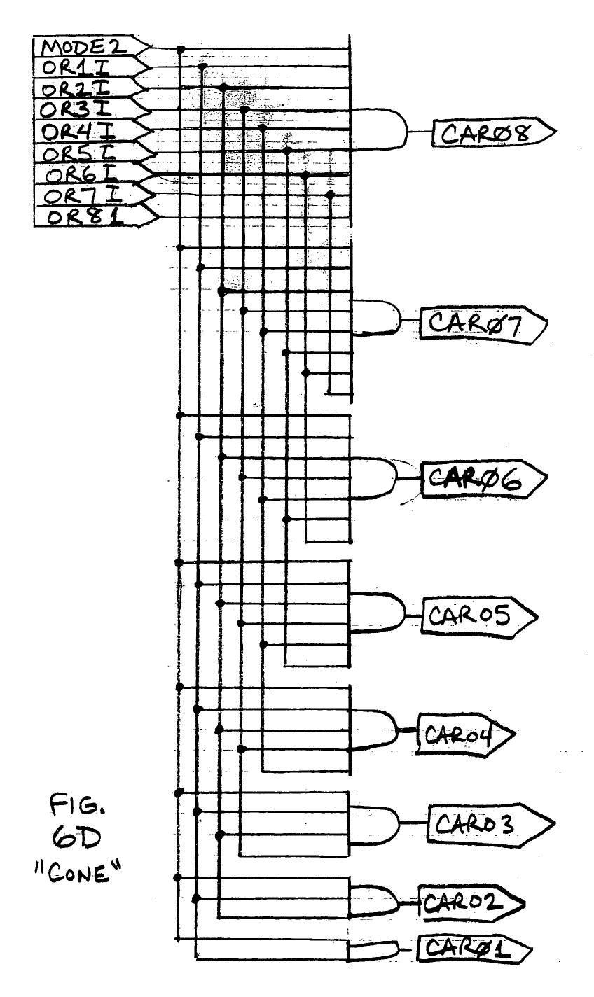

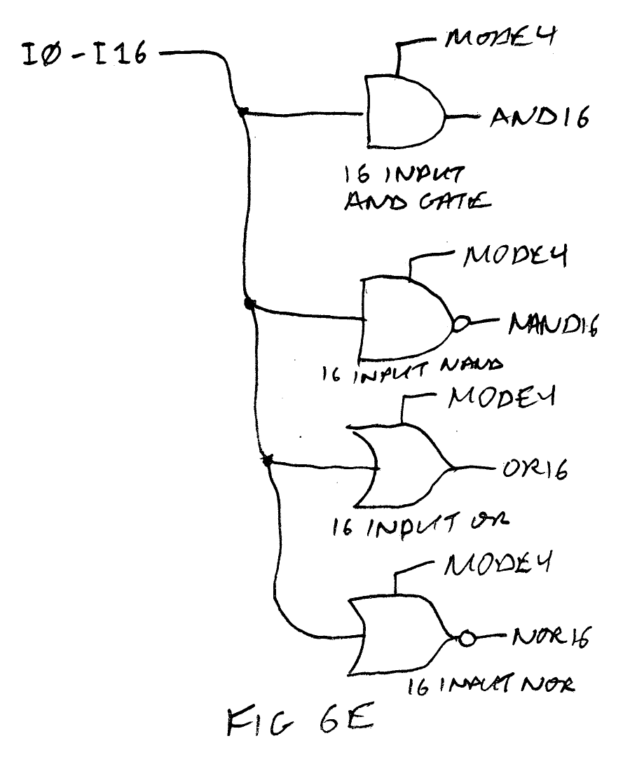

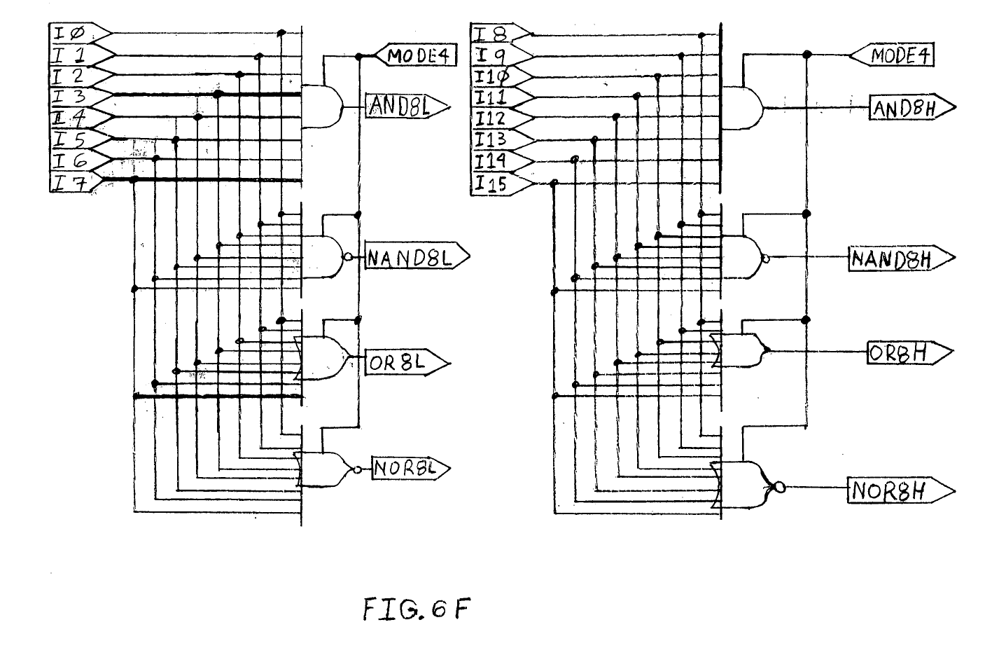

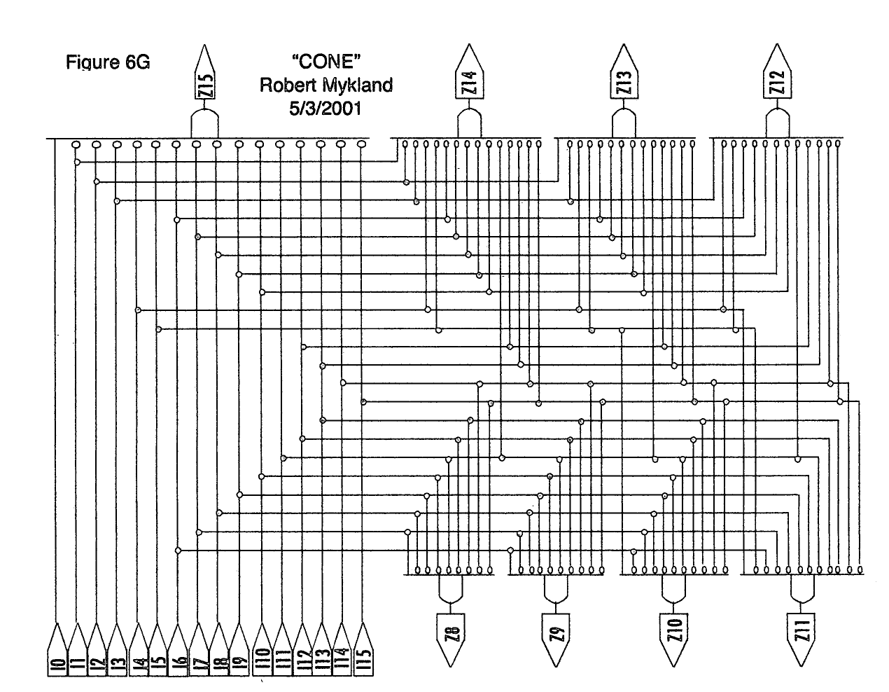

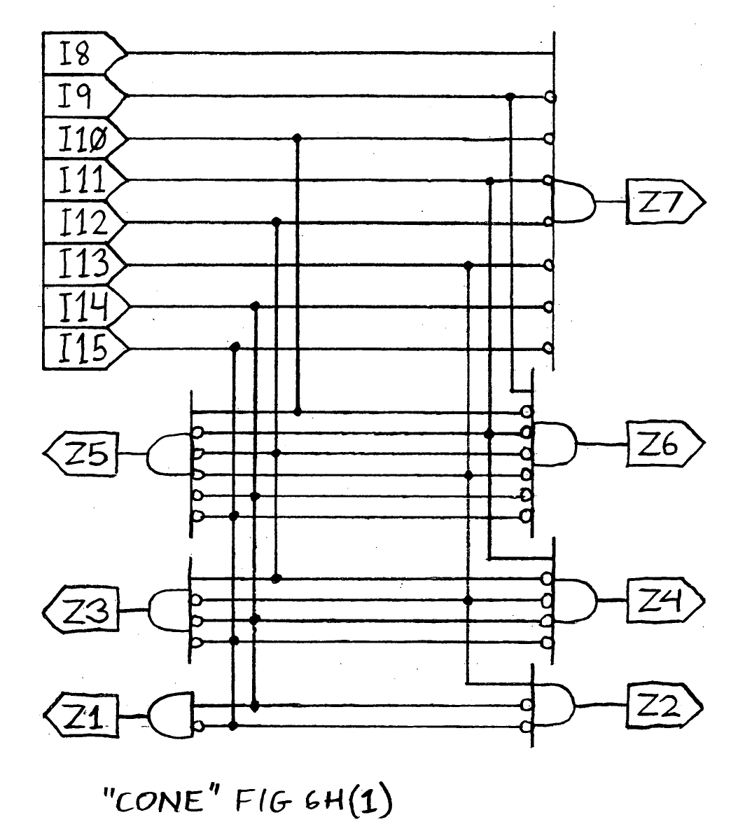

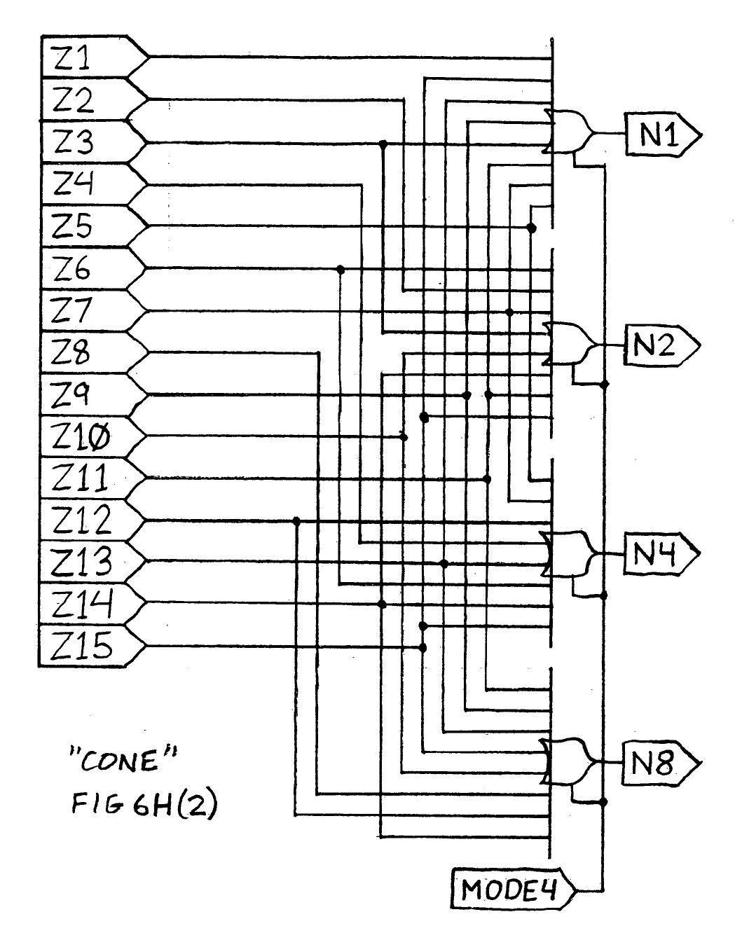

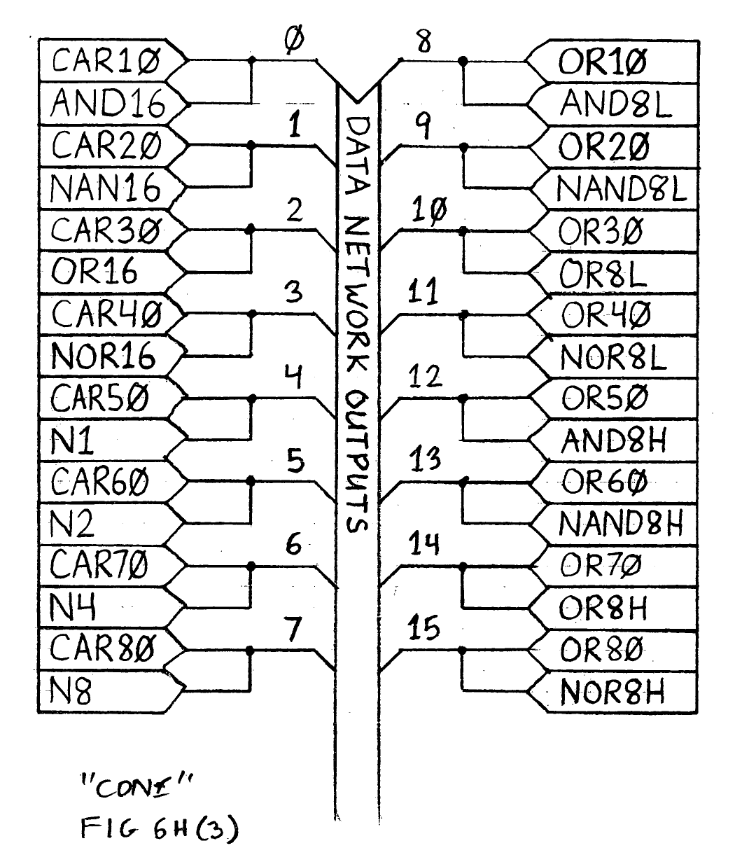

FIGS. 6A through 6H is a schematic diagram of a cone 38.

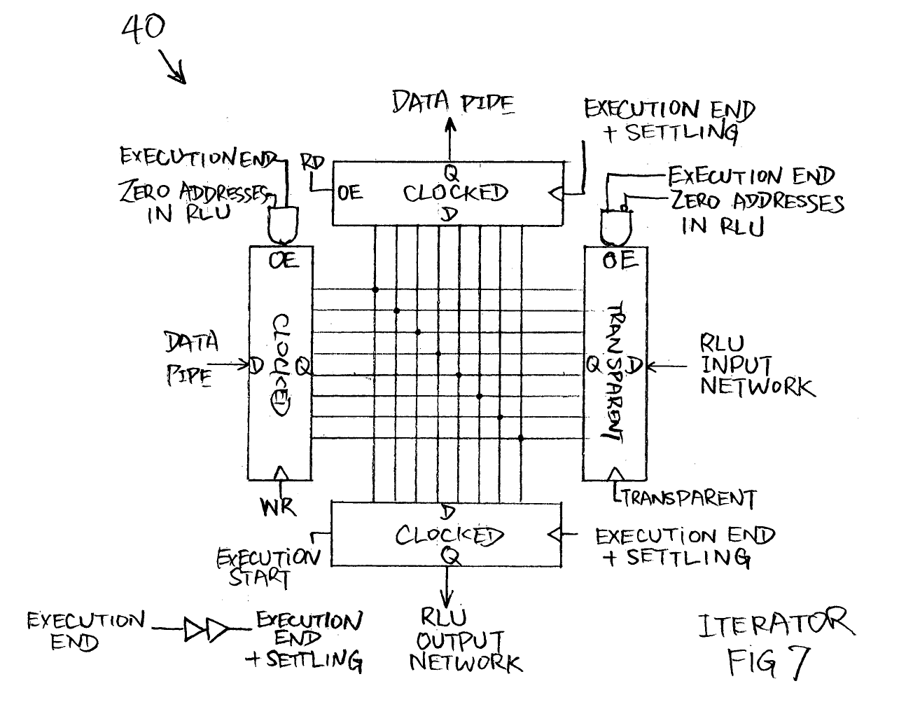

FIG. 7 is a schematic of a preferred embodiment of an iterator 40.

Referring now generally to the Figures and particularly to FIG. 8, a program flow 58 of an invented compiler of certain preferred embodiments of the present invention accepts a source code that may include or consist of a high level language software commands, data and/or program. The invented compiler then creates or generates processor software code that commands, configures, and/or reconfigures the invented processor 2 and/or the alternate invented processors 2 & 48 of FIGS. 1 and 2. The invented compiler then optimizes the processor software code for compression. The optimized processor software code is then compressed. The method of the present invention enables various preferred embodiments of the invented compiler to perform the source code compilation, processor software code compression optimization and the processor software code compression actions in efficient and coordinated temporal actions.

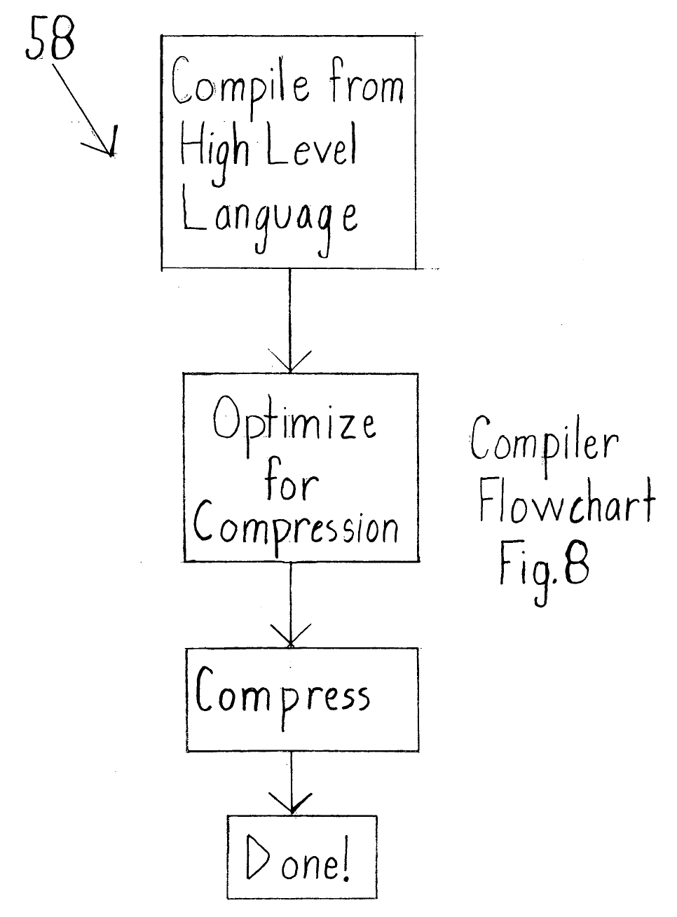

Referring now generally to the Figures and particularly to FIG. 9, the dynamic logic schematic 60 illustrating an aspect of a preferred embodiment of the method of the present invention teaches that the compressed processor software code is fetched by the invented processor 2 and decompressed. The decompressed processor software code is then used to configure the interconnections and/intraconnections within and among the muxes 36, the cones 38, the iterators 40, the look up tables 42, and other suitable functional logic circuits or suitable memory circuits of the RLU 8, the data pipe 10 and the present invention 2. The data pipe 10 fetches data and makes data available to the RLU 8 and the invented processor 2. The data pipe 10 may store data relating to or generated by the execution of a previous a previous instruction received from the RLU 8 or the invented processor 2. The invented processor 2 then loads decompressed configuration directions into the RLU 8 and begins an execution cycle. The method of the present invention enables the design and use of preferred embodiments of the present invention as described in the Figures in configuring the present invention and providing data to the data pipe 10 and the RLU 8, and managing data within the present invention, and performing an execution cycle, as described in FIG. 9.

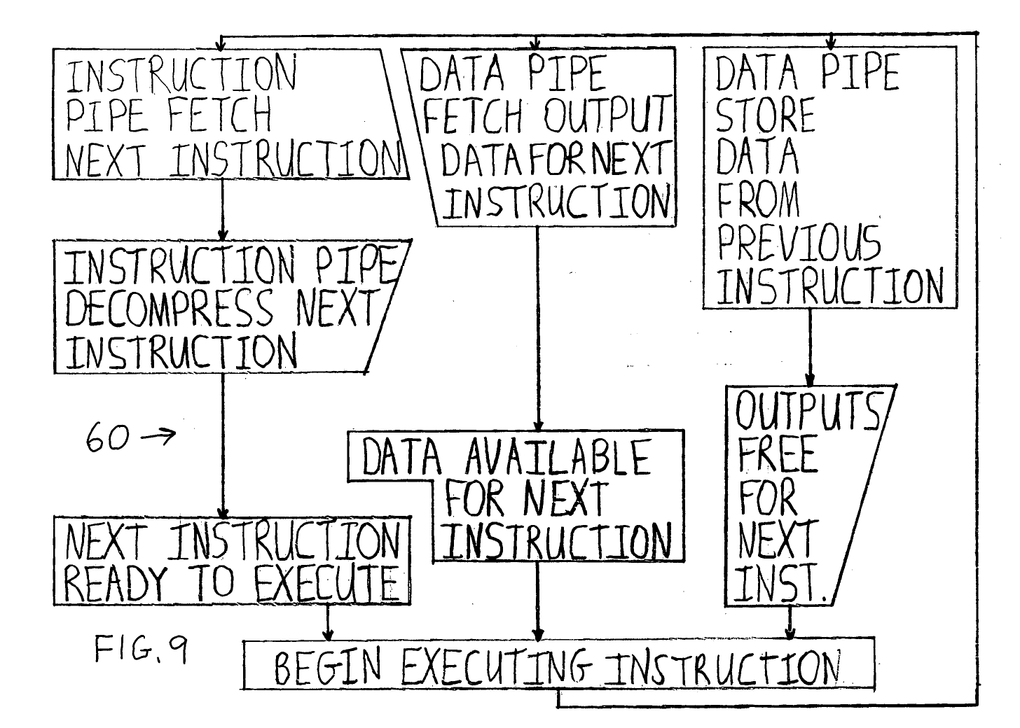

Referring now generally to the drawings, and particularly to FIG. 10, FIG. 10 is a schematic of a plurality of a preferred embodiment of a supercarry circuit 62.

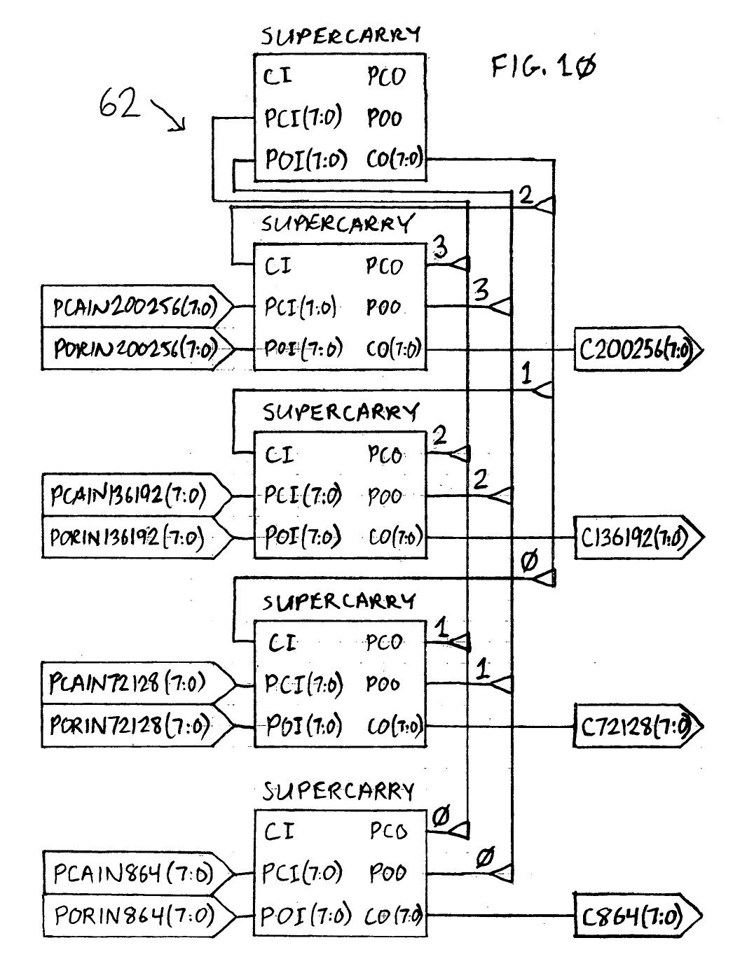

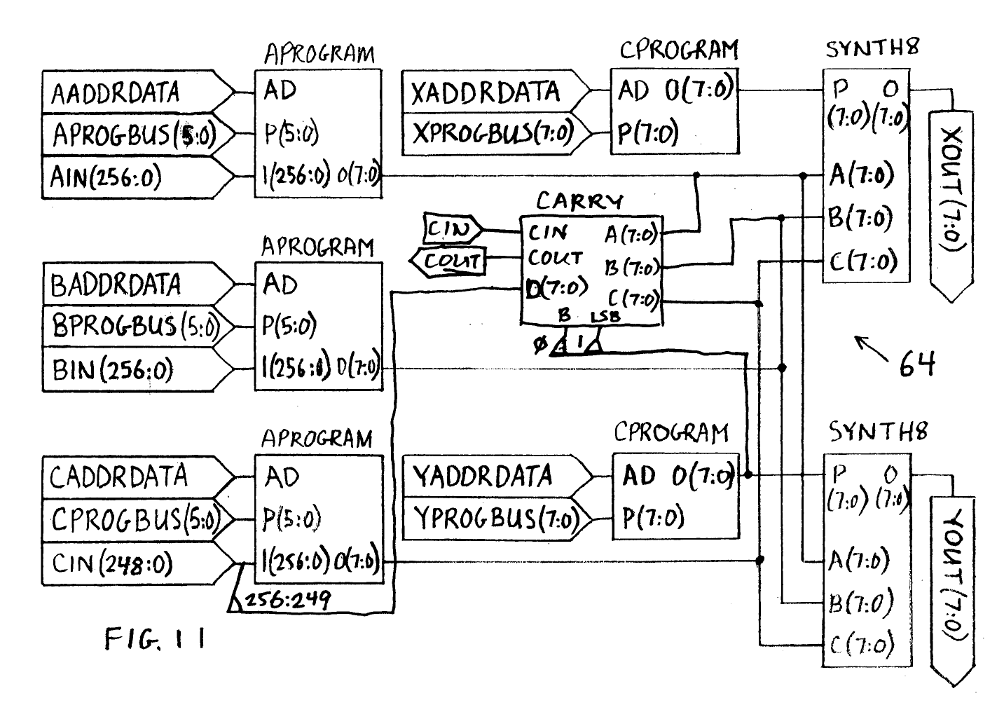

Referring now generally to the drawings, and particularly to FIG. 11, FIG. 11 is a schematic of a preferred embodiment of the mux circuit 64.

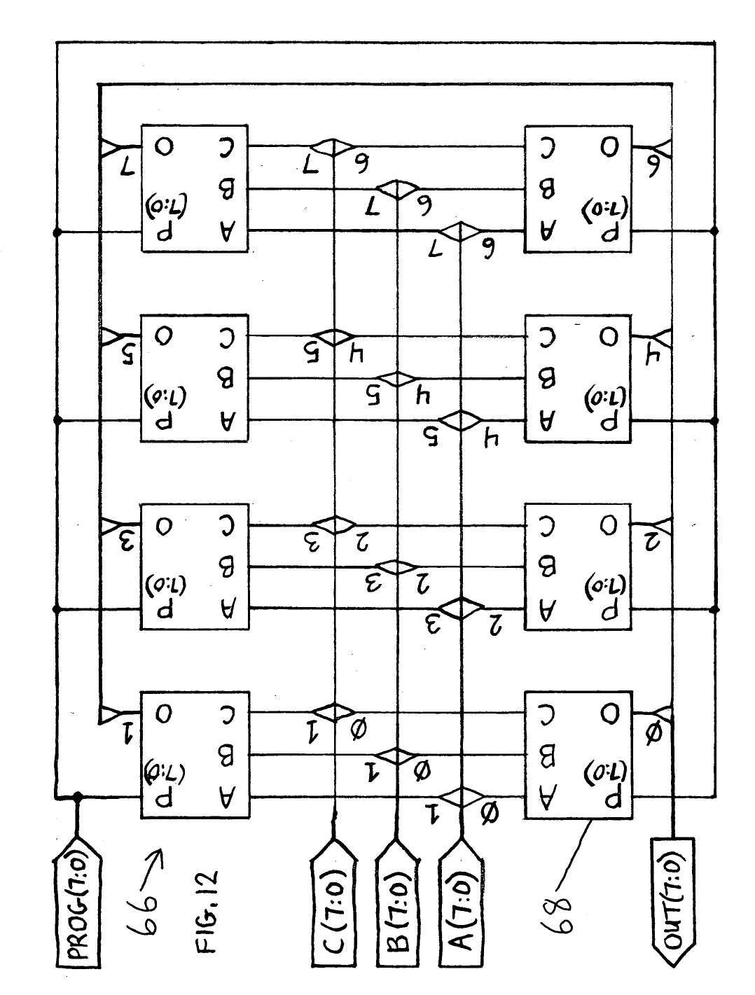

Referring now generally to the drawings, and particularly to FIG. 12, FIG. 12 is a schematic of a circuit 66 having eight alternate preferred embodiments of a mux circuit 68.

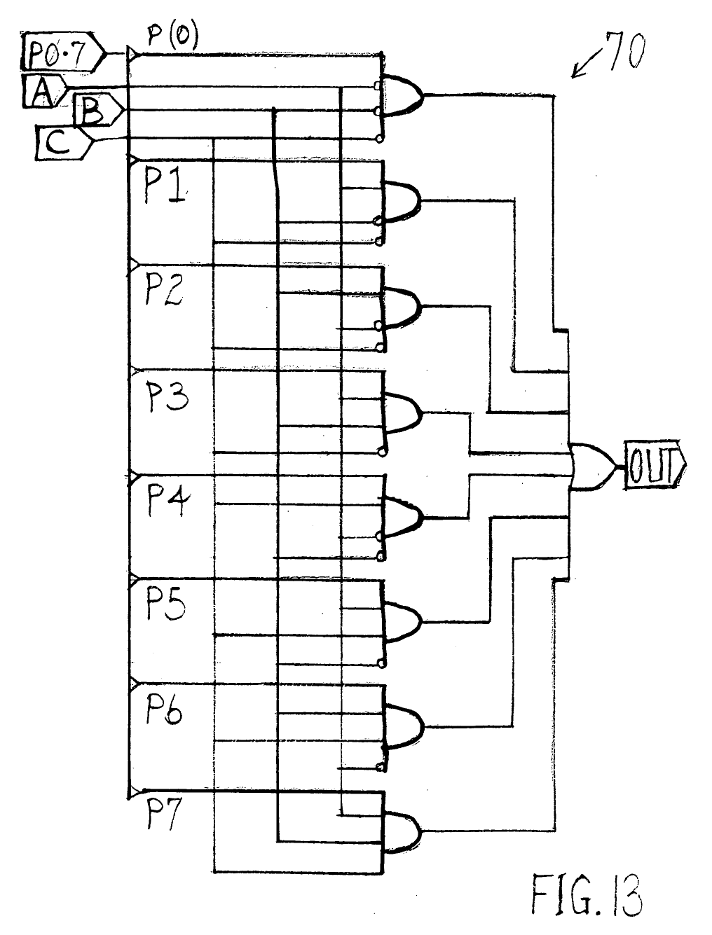

Referring now generally to the drawings, and particularly to FIG. 13, FIG. 13 is a schematic of a one bit wide mux circuit 70.

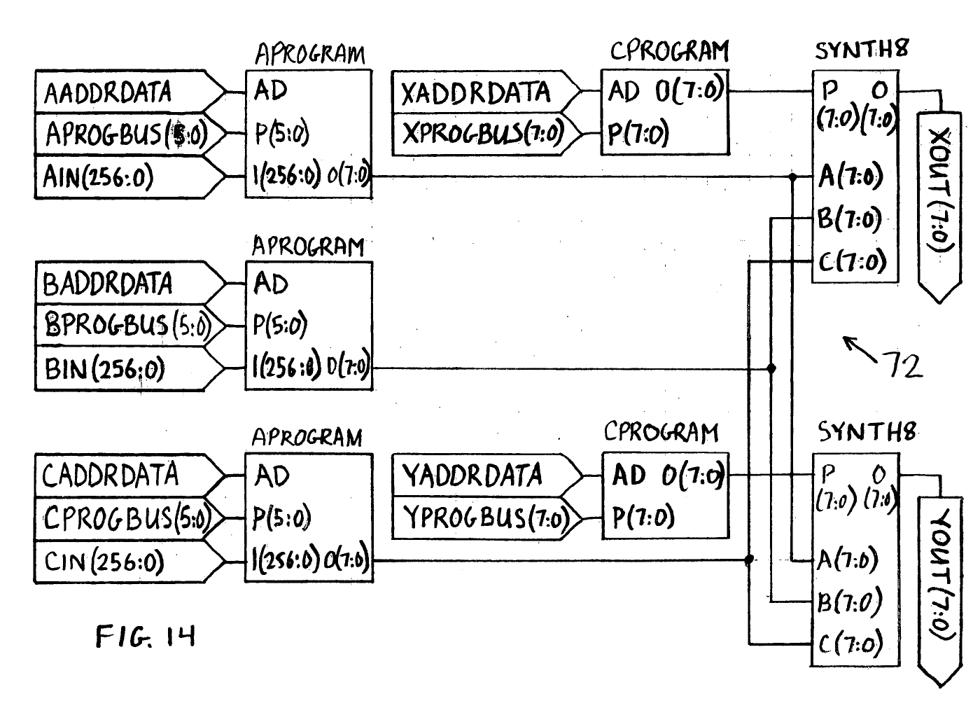

Referring now generally to the drawings, and particularly to FIG. 14, FIG. 14 is a schematic comprising a preferred embodiment of a mux 72 having a 3 byte input and a two byte output.

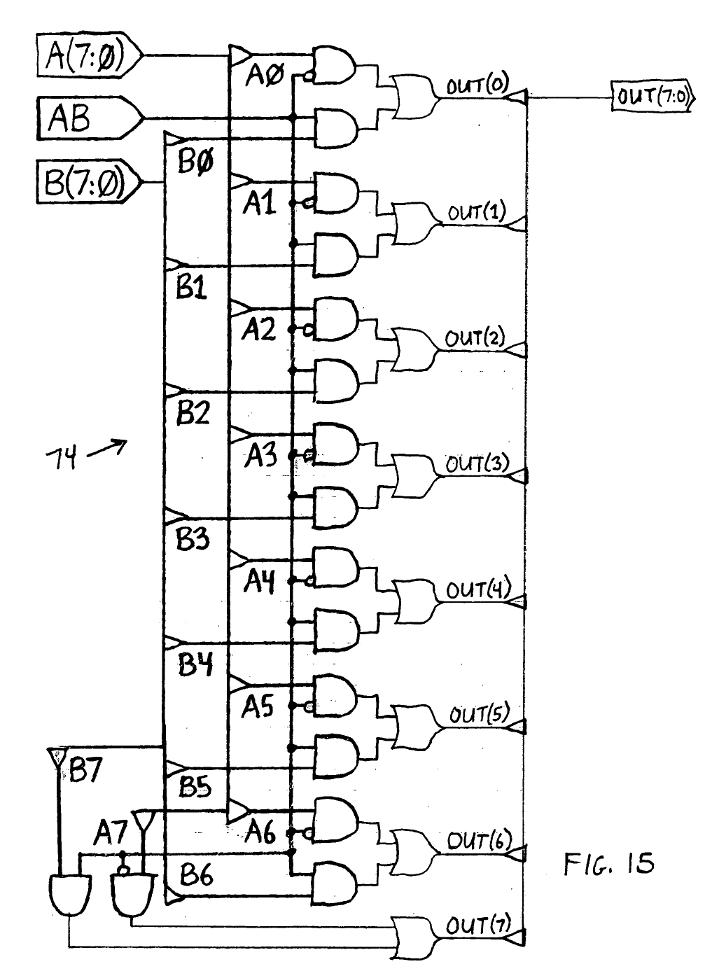

Referring now generally to the drawings, and particularly to FIG. 15, FIG. 15 is a schematic of a part of a preferred embodiment of an iterator circuit 74.

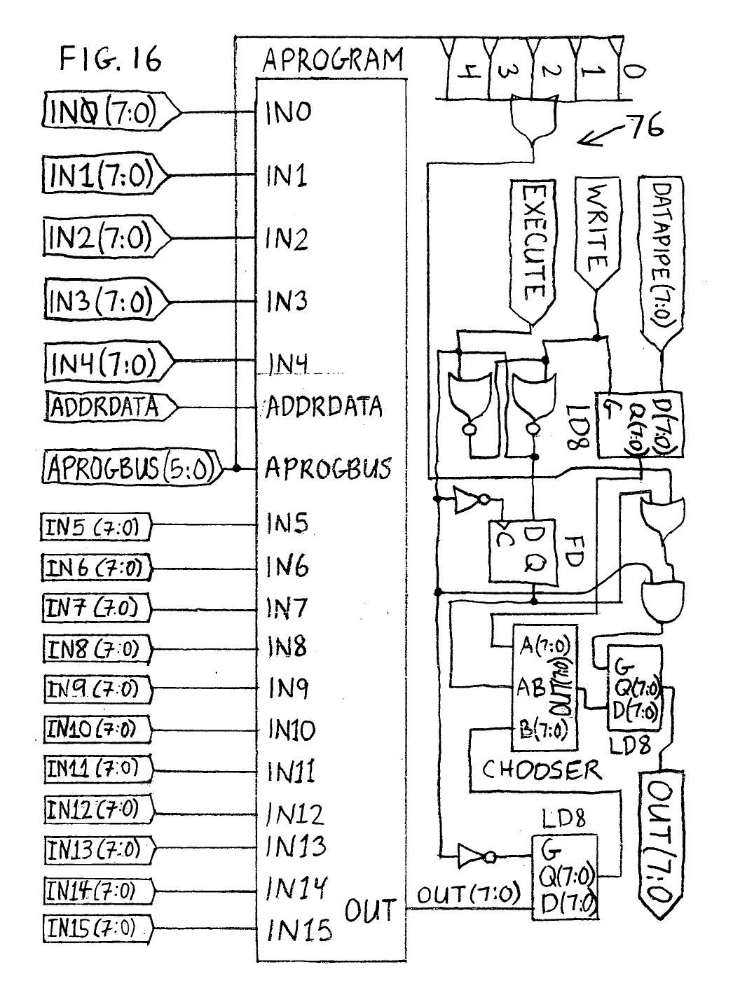

Referring now generally to the drawings, and particularly to FIG. 16, FIG. 16 is an alternate preferred embodiment of an iterator circuit 76.

Those skilled in the art will appreciate that various adaptations and modifications of the just-described preferred embodiments can be configured without departing from the scope and spirit of the invention. Algorithmic compression and decompression techniques, digital signature authentication methods, and public key cryptography applications, and other suitable authentication techniques and methods can be applied in numerous specific modalities by one skilled in the art and in light of the description of the present invention described herein. Therefore, it is to be understood that the invention may be practiced other than as specifically described herein.

I claim:

1. A central processor, the central processor coupled with a data source, data target and an instruction source, and the central processor comprising:
a reprogrammable logic unit, or RLU, the RLU comprising a reconfigurable plurality of logic circuits, and the RLU for accepting data and processing the data to produce a computational result, wherein the RLU performs computations by reconfiguring the plurality of logic circuits in accordance with an instruction and applying the input data to the configured plurality of logic circuits,
a bi-directional data pipe 10, the data pipe 10 coupled with the data source, the data target and the RLU, the data pipe 10 for providing input data from the data source and to the RLU for processing, and the data pipe 10 for communicating the computational result from the RLU and to the data target; and an instruction pipe, the instruction pipe coupled with the instruction source and the RLU,
and the instruction source for communicating instructions from the instruction source and to the RLU, wherein the instructions reconfigure the RLU, whereby the RLU is reconfigured to process the input data to produce the computational result.

2. The central processor of claim 1, wherein the data source and the data target are comprised within a memory.

3. The central processor of claim 2, wherein the instruction source is comprised within the memory.
